(19) United States
(12) Patent Application Publication
(10) Pub. No.: US 2022/0355839 A1
(43) Pub. Date: Nov. 10, 2022

(54) MONITORING, PREDICTING AND MAINTAINING THE CONDITION OF RAILROAD ELEMENTS WITH DIGITAL TWINS

(71) Applicant: KONUX GMBH, München (DE)

(72) Inventors: Christopher BOUCHER, Hobart (DE); Olga SPACKOVA, München (DE)

(21) Appl. No.: 17/624,316

(22) PCT Filed: Jun. 23, 2020
(86) PCT No.: PCT/EP2020/067525

§ 371 Date: Dec. 31, 2021

(30) Foreign Application Priority Data
Jul. 2, 2019 (EP) 19183976.0

(51) Int. Cl. B61L 23/04; B61L 27/53; G05B 23/02; G06Q 10/00

(52) U.S. Cl. CPC B61L 23/042; B61L 27/53; G05B 23/0283; G06Q 10/20

(57) ABSTRACT

The disclosure is directed to a method. The method comprises a data storing step that comprises storing data relating to a represented railway infrastructure system by a data processing system. The method further comprises a condition monitoring step that comprises estimating at least one condition of the represented railway infrastructure system at least by evaluating a set of monitoring models by the data processing system. The method further comprises a predicting step that comprises predicting at least one condition of said represented railway infrastructure system at least by evaluating a set of prediction models by the data processing system, and at least one model evaluation step that comprises evaluating at least one model of at least one condition of at least a portion of the represented railway infrastructure system by the data processing system. The represented railway infrastructure system comprises at least one component and at least one asset. The disclosure is further directed to a corresponding system and a corresponding computer program product.

### FIELD

The invention relates to fault prediction and predictive maintenance for railways and their associated elements. It is particularly directed to monitoring, estimating and predicting the condition and deterioration of railway components as well as providing means for optimized maintenance. Actual defects, maintenance and/or repair jobs and predicted defects or failures are taken into account for model-based representation of the railway system's elements as well as the maintenance optimization or recommendation.

### BACKGROUND

Railroad, railway or rail transport has been developed for transferring goods and passengers on wheeled vehicles on rails, also known as tracks. In contrast to road transport, where vehicles run on a prepared flat surface, rail vehicles (rolling stock) are directionally guided by the tracks on which they run. Tracks commonly consist of steel rails, installed on ties or sleepers and ballast, on which the rolling stock, usually provided with metal wheels, moves. Other variations are also possible, such as slab track, where the rails are fastened to a concrete foundation resting on a subsurface. An alternative are maglev systems etc.

Rolling stock in a rail transport system generally encounters lower than road vehicles, so passenger and freight cars (carriages and wagons) can be coupled into longer trains. Power is provided by locomotives which either draw electric power from a railway electrification system or produce their own power, usually by diesel engines. Most tracks are accompanied by a signalling system. Railways are a safe land transport system when compared to other forms of transport and are capable of high levels of passenger and cargo utilization and energy efficiency, but is often less flexible and more capital- intensive than road transport, when lower traffic levels are considered.

The inspection of railway equipment is essential for the safe movement of trains. Many types of defect detectors are in use today. These devices utilize technologies that vary from a simplistic paddle and switch to infrared and laser scanning, and even ultrasonic audio analysis. Their use has avoided many rail accidents over the past decades.

Railways must keep up with periodic inspection and maintenance in order to minimize the effect of infrastructure failures that can disrupt freight revenue operations and passenger services. Because passenger trains operate at higher speeds, steeper grades, and higher capacity/frequency, maintenance of the highspeed lines is especially important.

Since maintenance may overlap with operations, maintenance windows (nighttime hours, off-peak hours, altering train schedules or routes) must be closely followed. In addition, passenger safety during maintenance work (inter-track fencing, proper storage of materials, track work notices, hazards of equipment near states) must be regarded at all times. Moreover, maintenance access problems can emerge due to tunnels, elevated structures, and congested cityscapes. Here, specialized equipment or smaller versions of conventional maintenance gear are used.

Unlike highways or road networks where capacity is disaggregated into unlinked trips over individual route segments, railway capacity is fundamentally considered a network system. As a result, many components can cause system disruptions. Maintenance must acknowledge the vast array of a route's performance (type of train service, origination/destination, seasonal impacts), line's capacity (length, terrain, number of tracks, types of train control), trains throughput (max speeds, acceleration/deceleration rates), and service features with shared passenger-freight tracks (sidings, terminal capacities, switching routes, and design type). Maintenance activities can therefore considerably impact the availability of the railway network, not only in terms of tracks and the like, but also during the maintenance activities due to restrictions that apply to tracks where maintenance is ongoing. The impact gets more complicated to estimate as also the success of a maintenance measure is not completely clear in advance, as problems may occur during maintenance or further defects may be detected during maintenance activities.

Railway inspection is used for examining rail tracks for flaws that could affect the infrastructure availability or even lead to catastrophic failures. According to the United States Federal Railroad Administration Office of safety analysis track defects are the second leading cause of accidents on railways in the United States. The leading cause of railway accidents is attributed to human error. Every year, North American railroads spend millions of dollars to inspect the rails for internal and external flaws. Non-destructive testing (NDT) methods are used as a preventative measure against track failures and possible derailment.

With increased rail traffic at higher speeds and with heavier axle loads today, the demand on track infrastructure quality and health is increasing and rail inspection is becoming more important. In 1927, magnetic inductions had been introduced for the first rail inspection cars. This was done by passing large amounts of magnetic field through the rail and detecting flux leakage with search coils. Since then, many other inspection cars have traversed the rails in search of flaws. Nevertheless, the result of an inspection is associated with a certain tolerance and uncertainty. Additionally, manual and vehicle inspections only provide occasional information about the health of each inspected asset, they are typically conducted in an interval of a few months. Therefore, also continuous monitoring systems have been developed, providing a real time monitoring of critical parts of railway networks.

There are many effects that influence rail defects and rail failure. These effects include bending and shear stresses, wheel/rail contact stresses, thermal stresses, residual stresses and dynamic effects. Additionally, quality of the components, design, construction and commissioning of the infrastructure and its parts, as well as quality of maintenance can have a significant influence on the degradation processes. For rail switches, the degradation processes include rail degradation, such as wear and plastic deformation of the rails as well as fatigue, in particular rolling contact fatigue (RCF). Furthermore, the gauge as well as the geometry of the switch can degrade, i.e. deviate from the ideal form. The trackbed can degrade, as well as the fastening of the rails to sleepers. Also, the point machines, locking system and movable parts of the switch can degrade: The clearance between a stock and a corresponding switch rail can change, friction at the switch can increase, for example due to a lack of lubrication or there can be a misalignment of movable components. Furthermore, internal components or parts of the point machine can fail, such as bearings.

There are currently three modes of inspection:
1. Manual inspections that are performed by humans regularly or on demand.
2. Inspections performed by inspection vehicles, thus the inspection itself is automated but provides only occasional information about individual railway network component, which means that some degradation processes cannot be detected on time, and also limited possibility to precisely locate detected problems
3. Continuous monitoring systems that continuously monitor (critical) components and thus provide real time information about particular piece of the network.
Methods that are presently used to detect flaws in rails are e.g. visual inspections, ultrasound, eddy current inspection, magnetic particle inspection, radiography, magnetic induction, magnetic flux leakage, accelerometers, strain gauges and electric acoustic transducers.

For manual inspections, probes and transducers can be utilized on a “walking stick”, on a hand pushed trolley, or in a hand-held setup. These devices are used when small sections of track are to be inspected or when a precise location is desired. Many times these detail oriented inspection devices follow up on indications made by rail inspection cars or rail trucks. Handheld inspection devices are very useful for this when the track is used heavily, because they can be removed relatively easy. However, they are considered very slow and tedious, when there are thousands of miles of track that need inspection. Moreover, first indications of the defects can be only detected rather late.

For inspecting long sections of rail, track inspection vehicles are commonly used today. Those perform often ultrasonic testing, but there are some with the capability to perform multiple tests. These vehicles are loaded with high-speed computers using advanced programs that recognize patterns and contain classification information. The vehicles are also equipped with storage space, and depending on their tasks with tool cabinets and workbenches. A GPS unit is often used with the computer to mark new defects and locate previously marked defects. The GPS system allows a follow up car to find precisely where the lead vehicle detected the flaw. One advantage to such trucks is that they can work around regular rail traffic without shutting down or slowing down entire stretches of track.

With increased rail traffic carrying heavier loads at higher speeds and with increasing lack of skilled inspection and maintenance personnel, a more efficient and automatized way of inspecting and maintaining railways is needed. Besides that, also the control of the train- rail interaction would be advantageous; i.e., real time monitoring the loads and utilization of the railway infrastructure, identifying excessive loads disproportionally damaging the railroads, surveillance of the maintenance of trains or future failure thereof etc.

The term “monitoring”, e.g. in monitoring a condition of an element, can refer to supervising a current and/or past value of a measure and/or a variable, e.g. the condition of said element. It can further comprise a step of (automatically) estimating a measure and/or variable from (other) data, such as estimating from a condition another condition or a measurement. For example, monitoring a remaining thickness of a brake disc can comprise further calculations, based on a position and/or a measurement of a respective sensor. That is, monitoring the condition of the element is comparable to supervising the condition of the element at least indirectly, and monitoring can optionally comprise calculating, transforming and/or converting steps.

### SUMMARY OF THE INVENTION

The term “prediction” (or predicting) is intended to mean predictive analytics that encompasses a variety of statistical techniques from predictive modelling, machine learning, and data mining that analyze current and historic facts to make predictions about future or otherwise unknown events. That is, predicting, e.g. in predicting a condition of an element, can refer to estimating a future condition of the element. A future condition can refer to a condition that is associated with a time in future or of which no data is available yet. So, for example, if a system is predicting a condition of an element, then the system estimates the condition of the element for a time after the youngest data point that is available for the system. That is, future is to be understood relative to state of a system performing an estimation.

The term “estimation” (or estimating) is intended to mean the (semi-) automated finding of an estimate, or approximation, which is a value that is usable for some purpose even if input data may be large to finding an exact value, incomplete, uncertain, or unstable. For example, in “estimating a condition of an element”, estimating can refer to generating an estimation of the condition of the component or an unknown part of said condition. The unknown part can be unknown in spatial terms, e.g. if the condition is known at three points of the element, then estimating can refer to interpolation and/or extrapolating the condition at at least one other point of the element. The unknown part can also be unknown in temporal terms, for example when the unknown part of the condition is the condition at a future point of time.

The term “optimization” (or optimizing) is intended to comprise the (semi-) automated selection of a best available option (with regard to some criterion) or a set of best available options (with regard to some criterion or to multiple criteria) from some set of available options. It can be the best value(s) of some objective function given a defined domain (or input), including a variety of different types of objective functions and different types of domains.

The term “model” is intended to refer to simulation models or simulation methods that are configured to generate output data from input data when evaluated. In this sense, “evaluating” refers to performing actions indicated by the model, such as calculations, output or storing operations. A model can be an engineering model, such as a FEM- model, a structural dynamics model or a model based on chemistry or physics. A model can also be data-driven, such as a model based on at least one of statistics, probability theory, machine learning and artificial intelligence.
Models can be obtained from machine learning, such as supervised learning, unsupervised learning or reinforcement learning. Models can be based on statistics or probability theory. Further non-limiting examples are neural networks such as convolutional networks, deep convolutional networks, models obtained from deep learning or ultra-deep learning, genetic algorithms Markov models, hidden Markov models, Bayesian Networks, k-Nearest-Neighbours models (also referred to as kNN models), k-Means models, Support Vector Machines-models, Decision Trees (in the sense of decision trees for decision support/decision making process, as well as in the sense of decision trees for classification tasks), generalised linear models and Random Forest models.
Methods used as parts of models, for the creation of models and/or for pre-processing of input variables, e.g. for signal processing or dimensionality reduction, can comprise digital analytical methods, such as filter processing, pattern recognition, (functional) principle component analysis, Autoencoders, functional data analysis, independent component analysis, dynamic time warping, matrix factorisation.
Models can also be based on time-series analysis, such as on frequency-domain methods and time-domain methods. An example for a time-series analysis can be a break-point detection method.
Models can also be surrogate models generated using a model of the system that is based on physics or chemistry or that is an engineering model.

These analytical methods can be applied alone or any combination thereof, sequentially and/or in parallel. Models can comprise models. Models can also aggregate or combine results of other models, such as the models that they can comprise. A model can also be a cyclic loading model.

The term “condition” is intended to refer to a state of an element. The state can be a degradation, a type of the degradation, a severity of the degradation, a damage, a wear, a state of maintenance such as a sufficient presence of a lubricant or a type of a lubricant or a failure. It can also be a type of a failure, a presence of an anomaly, a remaining useful lifetime of the element, a performance of the element or a probability of a failure. A condition can comprise at least one or a plurality of other conditions. A condition can comprise conditions of portion(s) of the element. A condition can comprise conditions that refer to different aspects of the state of the element, such as a condition referring to a mechanical wear of a portion of the element and to a corrosion of the same or another portion of the element.

The term “railway infrastructure” is intended to comprise railway tracks, trackage, permanent ways, electrification systems, sleepers or crossties, tracks, rails, rail-based suspension railways, switches, frogs, point machines, crossings, interlockings, turnouts, masts, signaling equipment, electronic housings, buildings, tunnels, railway stations and/or informational and computational network. The term “network” in the context of railway infrastructure, railway infrastructure systems, components or assets is intended to refer to a railway network that comprises a plurality of elements of railway infrastructure. Such networks are intended to comprise a topography of the elements that they comprise. They can have operating rules, wherein these operating rules can specify admissible operation or operations, such as operations of vehicles moving in the network.

The term “assets” is intended to refer to elements of railway infrastructure that are configured to be parts of a railway network. An asset can be for example a switch, a crossing, a rail, a signal, a signalling system or the like.

The term “components” is intended to refer to elements of railway infrastructure that are configure to be parts of assets. A component of a switch can for example be a frog, a point blade, a guard rail or a switch motor. A component can comprise at least one or a plurality of parts. A component, its part(s) or portion(s) can be subject to one or a plurality of degradations.

The term “sensor” is intended to comprise at least one device, module, model and/or subsystem whose purpose is to detect parameters and/or changes in its environment and provides a respective signal to other devices. Parameters can be length, mass, time, current, electric tension, temperature, humidity, luminous intensity and any parameters derived therefrom such as acceleration, vibration, speed, time, distance, illumination, images, gyroscopic information, acoustics, ultra-sound, air pressure, magnetism, electro- magnetism, position, optical sensor information etc.

It is an object of the present invention to provide a method, system and computer program product for processing sensed data relating to a represented railway infrastructure system.

It is an optional objective of the present invention to provide a method, system and computer program product for estimating at least one condition of at least a portion of the represented railway infrastructure system.

It is another optional objective of the present invention to provide a method, system and computer program product for predicting at least one condition of at least the portion of the represented railway infrastructure system.

It is another optional objective of the present invention to provide a method, system and computer program product for optimising inspection activities and/or maintenance activities relating to the represented railway infrastructure system with regard to at least one of a need of resources to perform said inspection activities and/or maintenance activities, negative impacts on the represented railway infrastructure system caused by the inspection and/or maintenance activities, and at least one of a performance, reliability and availability of the represented railway network.

The present invention is directed towards a method comprising a data storing step that comprises storing data relating to the represented railway infrastructure system by a data processing system. The represented railway infrastructure system comprises at least one component and at least one asset. The data can also only be stored temporarily in the data storing step.

The data processing system can be a system configured to process data. It can comprise a computer. It can comprise a server. It can comprise an embedded data processing apparatus such as an embedded integrated circuit. It can comprise combinations and/or pluralities of the aforementioned devices. The data processing system can comprise computing devices at different geographic locations, such as for example two servers, a cloud computing system or at least one server that processes data from at least one embedded data processing apparatus located at another location, such as mounted to or next to an element of the represented railway infrastructure system.

The represented railway infrastructure system can also furthermore comprise at least one network.

The method can further comprise a model evaluation step. The model evaluation step can comprise evaluating at least one model of at least one condition of at least a portion of the represented railway infrastructure system by the data processing system. Evaluating a model is to be understood as performing a set of operations indicated by the model, such as evaluating a mathematical formula or performing steps of a method indicated by the model. A general example for the former can be calculating an RMS-value (root mean square value) of an acceleration signal which can represent a level of energy present in the signal. An example for the latter form of evaluating a model would be evaluating a trained machine learning, for example a k-nearest-neighbours model, to estimate a condition of a component of the represented railway infrastructure system, such as an overall health indicator of said component.

The method can also comprise a model generation step that comprises generating at least one model of at least one condition of at least a portion of the represented railway infrastructure system. The model generation step can optionally be performed by a model generator. The model generator can be a data processing system configured for model generation, that is, comprising software that is configured to generate a model. For example, in case of a regression model, the model generator can be configured to generate a model according to a pre-defined method, or the model generator can generate multiple models, e.g. with different parameters and/or by different methods, and then select a model that performs best in a performance criterion or a set of performance criteria.

The method can further comprise a condition monitoring step. Said condition monitoring step can comprise estimating at least one condition of the represented railway infrastructure system. This can be achieved at least by evaluating a set of monitoring models by the data processing system. That is, the step of estimation at least one condition of the represented railway infrastructure system can comprise evaluating a set of monitoring models by the data processing system.

The method can further comprise a predicting step that comprises predicting at least one condition of said represented railway infrastructure system. Said step of predicting at least one condition of said represented railway infrastructure system can comprise evaluating a set of prediction models by the data processing system.

Prediction models can be models configured for automated prediction, that is for evaluation by the data processing system, in order to generate a prediction. Monitoring models can be models configured for automated monitoring, that is for evaluation by the data processing system, in order to generate a monitoring result, for example at least one indicator indicating a condition of an element, wherein the indicator can be derived from data that is at least temporarily stored during the data storing step. The estimated and/or the predicted at least one condition can be a plurality of conditions. They can refer to different components, assets or networks, or to combinations of those elements. The at least one condition from the condition monitoring step can be the same as the at least one condition from the predicting step, or they can be different. The conditions can relate to different or same states of respective elements, such as mechanical wear and/or rolling contact fatigue of the rail.

The method can comprise furthermore a data quality estimation step that can comprise estimating at least one quality of data regarding the represented railway infrastructure system by the data processing system. The at least one quality of data can for example be a quantity of noise in a signal, a completeness of a data set, a measuring inaccuracy, a tolerance of a value or a confidence interval. Estimating a quality can also mean estimating an indicator for the respective quality, such as a relative indication of missing data points in a data set as an indicator for the completeness and/or bias of the data set.

The method can also comprise a model validity estimation step that comprises estimating at least one validity of at least one result of evaluating at least one model of the set(s) of models relating to the represented railway infrastructure system by the data processing system. This set or these sets can namely be at least one of the set of monitoring models and the set of prediction models. They can nevertheless also be other set(s) of models discussed in this disclosure. The at least one validity can for example be an accuracy or an uncertainty of an estimation or a prediction. The validity can also relate to the model itself, e.g. to errors that are inherent to the model itself and/or to its parameters. The validity can also relate to the step of evaluation the at least one model of the set of models as such, for example to the validity of a numerical approximation of a model's exact result.

The method can comprise furthermore an optimisation step that can comprise analysing and/or recommending at least one of inspection activities and maintenance activities for the represented railway infrastructure system at least by evaluating a set of optimisation models by the data processing system.

The method can further comprise performing at least one of maintenance and inspection activities according to results of the optimisation step. In particular, the method can comprise performing maintenance and/or inspection activities according to recommendations that result from the optimisation step.

The method can be a method for monitoring an infrastructure system.

The method can be a method for monitoring the represented railway infrastructure system.

The method can be a method for monitoring at least one condition of the represented railway infrastructure system. That is, the method can also be a method for monitoring at least one condition of an element, such as a part or a component, of the represented railway infrastructure system.

The method can be a method for predicting at least one condition of the represented railway infrastructure system.

The method can also be a method for monitoring and predicting at least one condition of the represented railway infrastructure system.

At least one of the at least one model that is evaluated in at least one for the at least one model evaluation step can further comprise stored data. Said stored data can relate to other railway infrastructure systems or parts thereof and/or to the represented railway infrastructure system or parts thereof. Said stored data can optionally also be data obtained from data relating to the respective infrastructure system(s) or part(s) thereof, which then still relates to the respective infrastructure system(s).

At least one model that is evaluated in the at least one model evaluation step can be a machine learning model.

At least one of said at least one machine learning model can comprise data relating to at least one element of at least one of the other railway infrastructure systems with similar properties to the modelled element. Such a machine learning model can either comprise at least a part of such data directly, for example in case of a knn-model, or data derived thereof, for example in case of a model based on multivariate linear regression.

At least one model that is evaluated in the model evaluation step can be a physics-based model representing at least one aspect of at least one condition of an element of the represented railway infrastructure system, for example a dynamic response of the switch or its component(s) to an excitation due to a passing train and/or passing trains. Such a condition of an element can also be a condition of one of its parts or portions, such as a model of degradation of the surface condition of the frog incl. fatigue and/or wear, or a model of crack initiation and propagation in the rail. In this disclosure, the term “physics- based model” is intended to be understood in a broad sense, that is, as a model based on laws of natural science(s) and/or engineering.

The model generation step can comprise adapting at least one physics-based model representing at least one condition of at least one element of the represented railway infrastructure system. Adapting the at least one physics-based model can refer to a calibration of the model. Adapting can also refer to a parameter identification for the model.

The data storing step can comprise furthermore storing sensed data that relate to at least one element of the represented railway infrastructure system. The sensed data can be sensed by at least one sensor, wherein at least one of these sensor(s) can be permanently mounted, mobile or mounted to a mobile unit, such as rolling stock, a drone or a truck. The sensor data can be directly or indirectly measured.

The data storing step can comprise furthermore storing load data that relate to a load of at least one element of the represented railway infrastructure system. The load data can be at least partially and at least indirectly acquired using at least one or a plurality of sensor(s) and/or using sensor data. The load data can comprise data about the traffic passing the element of the respective railway infrastructure system, such as a type of a passing train or a speed of a passing train.

The step of storing load data can comprise estimating at least a part of the load data based on the sensed data, wherein a portion of the sensed data that is used for this estimating can refer to the element whose load is to be estimated, but it can also refer to other element(s). As an example, for a railway track B between switches A and C, sensed data relating to switches A and C may be used in order to estimate the load data relating to railway track B.

The data storing step can comprise furthermore storing environment data that relate to at least one property of an environment of at least one element of the represented railway infrastructure system. Environment data can for example be meteorological data, such as temperature, humidity or precipitation. Environment data can also relate to other properties of the environment of the railway infrastructure system or a part of it.

The data storing step can comprise furthermore storing maintenance data. The maintenance data can relate to performed and/or possible maintenance activities of at least one element of the represented railway infrastructure system. The maintenance data can for example comprise data on the maintenance activities that were performed and/or that are planned, such as a type of the activity, e.g. manual tamping vs. machine tamping or even type of tamping tool/machine, location and time of the activity, reason of the activity and involved personnel. They can also comprise data on the performed maintenance activities' outcomes, such as “successful” or “not successful”, where appropriate to the respective operation. The maintenance data can also comprise information about maintenance activities that can be performed for the respective element. For example, a possible maintenance activity for a moving part can be a lubrification of said moving part, whereas lubrification is typically no appropriate maintenance activity for an electronical component. Also, lubrification is not necessarily a possible maintenance activity for every moving part, e.g. if a mechanical contact of a moving part is designed for dry friction, then lubrification may not belong to the possible maintenance activities that can be reasonably applied to this moving part.

The data storing step can also comprise storing inspection data that relate to performed and/or possible inspection of at least one element of the represented railway infrastructure system. Analogously to the considerations applying to maintenance data, the inspection data can comprise information relating to performed inspection activities. They can also comprise data relating to results or findings of at least one or a plurality of inspection activities. Furthermore, the inspection data can comprise data on possible inspection activities. Analogously to the maintenance data, the term “possible” is in this context to be understood as reasonably applicable from a technical point of view. For instance, measuring a mechanical wear of an electronical component is typically not possible.

Furthermore, the data storing step can comprise storing specification data that relate to at least one property of at least one element of the represented railway infrastructure system. Specification data specify a property of the element. Examples for specification data can be an element's geometry, an element's material composition, an element's manufacturer, an element's dimensional tolerance, or the like. Specification data can also relate to a function or a functional property of an element, such as operating rules of a network. Specification data can also comprise information regarding connections, interactions and/or interdependencies of an element to at least one or a plurality of other elements and/or to external/boundary conditions, in particular geological conditions at the location of the asset.

The data storing step can comprise a data processing step. The data processing step can comprise pre-processing the data. The data processing step can comprise operations to render data usable, to adapt their format and/or to integrate them into an existing set of data. The data processing step can also comprise calculating measures from descriptive statistics for data or parts thereof.

The data processing step can therefore comprise operations such as downsampling a signal, removing an offset from data or a part of data, such as data relating to a single variable and/or cutting segments from a signal. Signals are to be understood as input data in this context. Also, the data processing step can comprise operations such as processing of text or tabular data for storing, for example for storing maintenance data, when a documentation of executed maintenance activities is processed. Calculating measures from descriptive statistics for data or parts thereof can for example comprise calculating Root Mean Square-values, minimum-values, maximum-values and/or arithmetic means for a signal or a part thereof, in particular for parts of a signal that are defined by time intervals, so e.g. an arithmetic mean for a variable x(t) for each part of x(t) corresponding to an interval of t. A trivial example would be intervals of t with a length of one second and without overlap.

The data processing step can comprise filtering data.

The step of filtering data can comprise removing and/or omitting data that do not match a data quality criterion, such as a criterion relating to noise in a signal or data set, a criterion relating to a specified plausible range and/or other plausibility criteria, such as checksums of data sets or data points.

The step of filtering data can also comprise applying a digital filter to the input data.

The step of filtering data can also comprise detecting, analysing and/or filtering a saturated signal in the data.

The step of filtering data can also comprise compressing data or parts thereof.

The data processing step can comprise performing a functional data analysis.

The condition monitoring step can comprise a component condition monitoring step. The component condition monitoring step can comprise estimating at least one condition of at least one of the at least one component of the represented railway infrastructure system. Such a condition of a component could for example be its operativeness, at least one or a plurality of degradations or the like, which may be summarized by a component's “health”.

The condition monitoring step can also comprise an asset condition monitoring step. The asset condition monitoring step can comprise estimating at least one condition of at least one of the at least one asset of the represented railway infrastructure system. Such a condition can be analogous to the condition(s) of its component(s), or it can be a combination or agglomeration of the condition(s) of its component(s).

The condition monitoring step can also comprise a network condition monitoring step that comprises estimating at least one condition of at least one of the at least one network of the represented railway infrastructure system. Such a condition could for example be an availability of the network.

The component condition monitoring step can comprise estimating for at least one of the at least one component at least one of a degradation, a type of the degradation, a severity of the degradation, a location of a damage, a location of a degraded portion of the at least one component, a type of a failure, a presence of an anomaly, a damage and a probability of a failure. The component condition monitoring step can thus comprise generating degradation information. The at least one estimated measure can accordingly be referenced within this disclosure by “degradation information”. It is to be noted that estimating a degradation can also yield that a certain degradation has not (yet) happened or that a component is not subject to the certain degradation. Also, estimating the degradation information for the at least one component can comprise estimating the degradation information for a part or a portion of the component. For example, generating degradation information for a component comprising a bearing, as example for a part with a significant degradation, can be generating the degradation information for this bearing, or if there is a plurality of bearings, generating degradation information for some or all bearings and then agglomerating this information to degradation information regarding the component.

The asset condition monitoring step can comprise estimating for at least one of the at least one asset at least one of a degradation, a type of the degradation, a severity of the degradation, a type of a failure, a presence of an anomaly, a remaining useful lifetime and a probability of a failure.

The asset condition monitoring step can also comprise using at least one condition of at least one component of each of the at least one of the at least one asset.

The asset condition monitoring step can also comprise combining at least two conditions of at least one or a plurality of components of the at least one of the at least one asset of the railway infrastructure system. That is for example, the asset condition monitoring step can comprise agglomerating or combining degradation information of the at least one or a plurality of component(s) of the asset, for example to an aggregated indicator of asset health.

The network condition monitoring step can also comprise combining data relating to at least one condition of at least one asset of the network. That is, the network condition monitoring step can comprise combining data relating to a plurality of conditions of the at least one asset of the network, wherein the conditions can relate to a same asset or a same portion of an asset and be of a different type, they can be of a same type and relate to different portions of the network, such as different assets or different portions of an asset, or at least some of the conditions that are combined in the network condition monitoring step can be different from each other in both ways.

The network condition monitoring step can also comprise combining data relating to at least one condition of at least one asset of the network and data on at least one of a topology of the network and operating rules of the network.

The set of monitoring models can comprise at least one model based on a time-series analysis. This can refer to an analysis in a frequency-domain or a time-domain as well as the methods for analysis in the time- and/or frequency-domain. Frequency-domain signal analysis, such as spectral analysis, can be optionally advantageous to extract features from acceleration data. Time-series analysis can be furthermore optionally advantageous for calculating displacements by processing, such as filtering and integrating the acceleration signal. Time-series analysis can also be optionally advantageous to detect problems with a corresponding sensing unit, for example improper fastening of the sensor units or failures of sensors of the sensor unit.

The set of monitoring models can comprise at least one data-driven model. That is, the set of monitoring models can comprise a model that is data-based, such as a machine learning model or a neural network. In this disclosure, neural networks are considered to be a part of machine learning models, too.

The set of monitoring models can comprise at least one supervised machine learning model. A supervised machine learning model is a model obtained from supervised learning. Supervised machine learning models are intended to also comprise neural networks that are suitable for supervised learning.

Furthermore, supervised machine learning models can be advantageous for estimating a condition of an element, for example a severity of a degradation. Said estimating can comprise using (a) feature(s) extracted from sensed data or data that were processed in the data processing step, such as an RMS-value of a current signal, an acceleration signal and/or features extracted from the spectral analysis of the acceleration signal.

A supervised machine learning model can be a regression model, that is, it outputs a continuous variable such as a speed of a train or a health indicator relating to a particular component. A supervised machine learning model can be a classification model, that is, it outputs discrete values, such as classes, types and/or categories, for input values.

The set of monitoring models can also comprise at least one unsupervised machine learning model. An unsupervised machine learning model is a model obtained from unsupervised learning. An unsupervised machine learning model can also be a neural network configured for unsupervised learning. An unsupervised machine learning model can be optionally advantageous for detecting anomalies in conditions of elements, such as components or assets, for pre-processing/filtering input variables of some models where clustering can be used for removing outliers or for partitioning a signal and selecting segments for further analysis.

The set of monitoring models can also comprise at least one reinforcement learning model. An reinforcement learning model is a model obtained from reinforcement machine learning. A reinforcement learning model can be optionally advantageous for optimisation purposes.

The set of monitoring models can also comprise at least one model based on a regression analysis.

The set of monitoring models can comprise at least one physics-based model. That is, a model that is based on a consideration motivated by laws of natural sciences and/or engineering, such as a FEM-model, a structural dynamics model, a model simulating a progress of a deterioration as function of time or cumulative load or any other model based on chemistry or physics.

The set of monitoring models can comprise at least one model based on a break-point detection method. Using a break-point detection method can be optionally advantageous to detect sudden changes in the condition of the monitored assets. Such changes can be for example changes due to environmental conditions, but also due to changes of the component/asset due to conducted maintenance works.

The set of monitoring models can comprise at least one physical structural-dynamics model. A structural dynamics model can be optionally advantageous to model relations between variables that cannot efficiently be learned from data, such as, in case of a switch, temperature effects or effects of a railway substructure and/or subsoil on sensed data.

The condition monitoring step can comprise at least one of the at least one model evaluation step. Evaluating the set of monitoring models can comprise said at least one of the at least one model evaluation step. Evaluating the set of monitoring models can also be at least one of the at least one model evaluation step.

The predicting step can comprise estimating at least one of a point estimate and limits of an interval related to the development of a quantity relating to a condition of an element in future. A point estimate can for example be an arithmetic mean, a median, or a certain quantile. The point estimate can describe how the quantity evolves in time. It can be depending on a parameter, such as time. The point estimate can also be an estimation of a remaining useful lifetime or of a probability of failure or a certain limiting unhealthy state in a certain time interval. The limits of the interval can for example be limits of an interval containing the remaining useful lifetime or the probability of failure in a certain time interval with a certain confidence. The limits of the interval can also depend on a further parameter, such as time. For example, the limits of the interval can be estimations of an upper and a lower limit of a length of a crack as measure for an exemplary condition in a part at different times. The parameter can also be a number of load cycles, so that in the preceding example, the measure of said exemplary condition, i.e. the crack length, would be parametrized by the number of load cycles.

The limits of the interval related to the development of the quantity can be confidence limits of said interval.

The predicting step can comprise estimating characterising values of a prediction model of the set of prediction models representing the development of the quantity relating to the degradation of the element in future and thus generating at least one degradation estimation with uncertainty quantification. Those characterising values can for example be parameter values of a model. The uncertainty quantification can be a confidence indication, but it can also be another measure for an uncertainty of the estimation.

The predicting step can comprise evaluating a prediction model of the set of prediction models representing the development of a quantity relating to a degradation of an element in future, wherein said prediction model represents the development at at least one point of time in future, preferably a plurality of points of time in future and still more preferably an interval of time in future. In this context, the considerations regarding the word “future” made at the beginning of the summary of the invention are to be noted in particular.

The prediction models referred to in the two preceding paragraphs can be a same prediction model.

The predicting step comprises predicting for at least one element of the represented railway infrastructure system at least one of a degradation, a type of the degradation, a severity of the degradation, a type of a failure, a presence of an anomaly, a remaining useful lifetime, a performance and a probability of a failure, and thus generating prediction information for the at least one element.

At least one model of the set of prediction models that represents a condition of an element of the represented railway infrastructure system can be obtained from or updated with data relating to said condition of the element.

At least one model of the set of prediction models that represents a condition of an element of the represented railway infrastructure system can be obtained from or updated with data relating to a corresponding condition of at least one other element of a corresponding type. The at least one other element of a corresponding type can be a part of the represented railway infrastructure system, or of another railway infrastructure system. In cases where the at least one other element of a corresponding type is a plurality of such elements, at least one, all or none of the plurality of elements of a corresponding type can be part of the represented railway infrastructure system. The corresponding type can be a functional type, such as the type “switch”. The corresponding type can also be a certain model type, such as a certain type of switch, signal, rail, fastener or the like. The corresponding type can also relate to a material from which an element is made, such as elements made from a particular type of steel, or elements comprising a certain material, for example a polymer that degrades remarkably depending on the environmental conditions.

The set of prediction models can comprise at least one model that represents a future development of at least one condition of an element of the represented railway infrastructure system as a function of at least cyclic loads of the element.

The set of prediction models can comprise at least one model that represents a future development of at least one condition of an element of the represented railway infrastructure system as a function of time.

The predicting step can comprise at least one of the at least one model evaluation step. More specific, evaluating the set of prediction models can comprise at least one of the at least one model evaluation step. Evaluating the set of prediction models can also be at least one of the at least one model evaluation step.

The predicting step can comprise a component predicting step that can comprise predicting at least one condition of at least one of the component(s) of the represented railway infrastructure system.

The predicting step can also comprise an asset predicting step that can comprise predicting at least one condition of at least one of the asset(s) of the represented railway infrastructure system.

The predicting step can also comprise a network predicting step that comprises predicting at least one condition of at least one of the network(s) of the represented railway infrastructure system.

The component predicting step can comprise evaluating at least one model from the set of prediction models, wherein the at least one model represents a future development of at least one of the at least one condition of the component as a function of data of at least one data type selected from sensed data, load data, environment data, maintenance data, and specification data. The data of the at least one data type can relate to the component or to an asset that comprises the component.

The component predicting step can comprise aggregating predictions for different deterioration process of a component, such as a wear of a rail and a deviation from an optimal track geometry.

The prediction can also be made directly for a defined health indicator, such as by evaluating a model that is configured to estimate said defined health indicator directly based on input data.

The component predicting step can comprise evaluating a physical deterioration model. The set of prediction models can correspondingly comprise a physical deterioration model.

A physical deterioration model can for example be used if there are only few data relating to a particular deterioration process.

The component predicting step can comprise evaluating a statistical deterioration model. The set of prediction models can correspondingly comprise a statistical deterioration model.

A statistical deterioration model can for example be used to estimate a deterioration process as a function of cumulative load passing by an element, such as sum of tonnage passing by a switch or a cumulative RMS-value of an acceleration signal of a switch that is measured.

The component predicting step can also comprise combing the step of evaluating a physical deterioration model and a statistical deterioration model, such as by predicting at least one condition by the physical deterioration model until there is a sufficient amount of data to use the statistical deterioration model.

The component predicting step can further comprise utilizing at least one type of sensed data to evaluate at least one model of the set of prediction models.

The asset predicting step can comprise combining results of at least one component predicting step for at least one component of the asset. The asset predicting step can comprise combining predictions of a plurality of conditions, wherein these can relate to a same or to different components. The conditions can be of a same type or of a different type. For instance, the asset predicting step can comprise combining conditions of respective mountings of a plurality of components of a switch. The asset predicting step can for example also comprise combining conditions that led to failures of similar switches most frequently in the past.

The network predicting step can comprise predicting an availability of at least one route in the at least one network at a future point in time.

The network predicting step can comprise predicting a capacity of at least one route in the at least one network at a future point in time.

The method can comprise predicting the condition of at least two elements of the network, such as by performing at least one of the component predicting step and the asset predicting step, and the network predicting step can comprise combining the predicted conditions of the at least two elements with the topology and/or operating rules of the network.

The set of prediction models can comprise at least one model based on a time-series analysis. The model can for example be a model that is based on at least one of a frequency-domain method and a time-domain method.

The set of prediction models can comprise at least one model based on a regression analysis. A regression model can be optionally advantageous for forecasting a development of a deflection of a track caused by passing trains. An availability of said deflection can be optionally advantageous as indicator for a state of a corresponding trackbed.

The set of prediction models can comprise at least one model based on random processes, such as Markov processes, hidden Markov processes or Poisson processes. The set of prediction models can optionally also comprise a model based on another random process.

A model based on a Markov process can be optionally advantageous for forecasting an evolution of a degradation process and/or a health indicator. In such a case, the model can be trained with historic data from the represented asset and/or data from other assets. The other assets can be of a comparable or same type.

A Poisson process can be optionally advantageous to model sudden failures that do not result from observable degradation processes. An example for such a failure could for example be a blockage of a locking system by a stone or another object.

The set of prediction models can comprise at least one supervised or unsupervised machine learning model. For example, a model can be based on a classification analysis.

As stated above, in this disclosure, the term “machine learning model” is intended to also cover neural networks.

The set of prediction models can also optionally comprise a reinforcement learning model.

The set of prediction models can comprise at least one physical deterioration model. The set of prediction models can for example comprise a structural-dynamics model.

Optionally, the set of prediction models can also comprise a surrogate model generated using a physical model of the system.

The set of prediction models can comprise at least one survival model.

The model validity estimation step can comprise estimating a quantified property of the at least one result of evaluating the at least one model of the set(s) of models, such as a measure for an error, a variance or a bias of at least one model. The considerations above apply respectively. As discussed above, the model validity estimation step can be performed for any set of models discussed in this disclosure, that is, also for the set of optimisation models.

The data quality estimation step can comprise estimating at least one of the at least one quality of at least one of sensed data, load data, environment data, maintenance data, inspection data and specification data. The data can be according to any of the preceding embodiments that comprise the respective data.

The optimisation step can comprise recommending at least one of a type and a timing of at least one of the inspection activities and the maintenance activities for at least one element of the represented railway infrastructure system. That is, the optimisation step can comprise recommending the type of inspection activities and/or a type of maintenance activities. The optimisation step can also comprise recommending a timing for the inspection activities and/or the maintenance activities. The optimisation step can also comprise recommending said timing and type of activities for each type of activities or for only one type of activities. The optimisation step can also comprise recommending a type of inspection activities and a timing of maintenance activities or vice versa. Recommending a type of inspection activities and a timing of maintenance activities can be optionally advantageous to enables effective utilization of recourses, for example as it can lead to improved safety and working conditions of maintenance workers and maximized the availability of the represented railway network. For example, the optimisation model can recommend optimal intervals between inspections for each monitored switch individually, depending on an actual load of the switch, on its current and/or predicted health and/or based on other switch-specific parameters, such as age, health history and/or construction quality.

The optimisation step can comprise recommending an order of the inspection activities and/or the maintenance activities. For example, an optimisation model can find an optimal order of maintenance activities (e.g. a frog exchange followed by a machine tamping) to be carried out on an asset to maximise their efficiency and minimise the negative impact on the asset/network availability. The recommending can optionally further comprise recommending a timing of operations, for example the frog exchange followed by the machine tamping 1 month later.

The optimisation step can comprise recommending resources for at least one of the inspection activities and the maintenance activities. Said resources can for example be human resources, tools and/or machinery.

Said recommending resources can comprises recommending inspection resources for the inspection activities. Said recommending resources can also comprise recommending maintenance resources for the maintenance activities. The maintenance resources and the inspection resources do not need to be mutually distinct, but they can also be at least partially overlapping or even entirely identical, for example if personnel that can perform some inspection activities can also perform some maintenance activities. Another example can be vehicles for transportation of personnel and/or machinery to an element of the represented railway infrastructure system for maintenance activities as well as for inspection activities.

The optimisation step can comprise representing at least one activity of the inspection activities and/or the maintenance activities for at least one element of the represented railway infrastructure system by at least one model of the set of optimisation models.

Said representing at least one activity can for example comprise representing probabilities of different outcomes based on other variables. For example, an uncertain effect of maintenance activities on an asset's health can optionally be modelled probabilistically, predicting how effective and sustainable said activities are, i.e. to which extent they improve the health of the asset and how long such an improvement will last. In another example, said representing at least one activity can comprise representing a need of resources depending on further conditions, for example a time for inspecting a part of a component depending on whether other parts of the same component are also inspected, in a case where inspecting the component requires further measures, such as closing a track and/or dismount the component from an asset to which the component belongs.

The optimisation step can comprise representing for at least one or each of the maintenance activities at least one of a possible influence or possible influences on the respective element, a possible influence on at least one other element, a need of resources, an uncertainty of an influence of the maintenance activity, and a degradation, a degradation process or a failure that the maintenance activity may influence. Any of the aforementioned can be represented by at least one model of the set of optimisation models.

The optimisation step can comprise representing for at least one or each of the inspection activities at least one of a possible influence on a quality of data relating to the respective element, a possible influence on a validity of at least one result of evaluating a model of a set of models relating to the element, a possible influence on the respective element, a possible influence on at least one other element, a need of resources, and a degradation, a degradation process or a failure that the inspection activity may reveal. Any of the aforementioned can be represented by at least one model of the set of optimisation models.

In the two preceding paragraphs, representing a “possible influence” can also comprise representing said influences together with a confidence interval, representing possible influences each with a respective probability or a respective estimation thereof, and/or representing said influences with another measure for an uncertainty or likelihood of the respective influences.

The optimisation step can comprise estimating an impact of at least one activity from the inspection activities and the maintenance activities on an availability of at least one route in the at least one network by combining their impact on the respective elements of the represented railway infrastructure system with a topology and/or operating rules of the network. Example for such impacts can be a necessity to close a track or other side effects of performing an inspection or maintenance activity on an availability of other elements. That is, in this disclosure, an “impact” of an activity is intended to refer to side-effects of an activity, in particular concerning other elements of a railway infrastructure system, and an “influence” is intended to refer to a result of an activity relating mainly to the element for which the activity was performed.

The optimisation step can comprise representing performed activities of the at least one of the inspection activities and the maintenance activities. The optimisation step can also or alternatively comprise representing at least one or a plurality of impacts of said performed activities.

The optimisation step can comprise estimating for each of a plurality of combinations of activities from the at least one of the inspection activities and maintenance activities at least one possible outcome. Said estimating an outcome for combinations of activities can comprise for example summing up effects of each of the activities independently from each other. It can also comprise considering dependencies of at least some activities in a combination of activities. The outcome is to be understood as a holistic outcome of a combination of activities. For example, the outcome can comprise a state of elements of which a combination of activities was performed, an uncertainty or a measure for probabilities of different outcomes or a respective measure therefore as detailed above, and/or resources necessary to perform said combination of activities or a measure therefor.

The optimisation step can further comprise estimating at least one other influence and/or impact of each of the combinations of activities, wherein said at least one other influence and/or impact is represented for at least one of the activities by at least one model of the set of optimisation models.

The optimisation step can further comprise selecting at least one combination of activities from the plurality of combinations of activities based on an optimization criterion. As an example, the optimization criterion can specify how a result translates into a utility of a measure, how a need of resources translates into cost, and/or how durations and/or timings of different measures translate into an overall time until a certain result is achieved.

The optimisation step can further comprise applying a constraint or a set of at least one or a plurality of further constraint, such as a time of completion, constrains relating to limited resources or constrains resulting from existing inspection, maintenance and safety rules such as a maximum acceptable degradation level or maximum time between two inspections. There can also be further constraints relating to the represented railway infrastructure system, for example an accessibility of elements of a network when measures are performed for other elements. An example could be different works relating to a bridge, wherein works at the structure of the bridge may be conflicting with works on the rails on the bridge.

The optimisation step can comprise using at least one result of the predicting step. For example, a predicted degradation can be used for optimising maintenance activities.

The optimisation step can comprise furthermore using prediction information for at least one element of the represented railway infrastructure system.

The optimisation step can comprise at least one of the at least one model evaluation step.

The set of optimisation models can comprise at least one of a model based on a cost benefit analysis, a model based on utility analysis, and a model based on a multi-criteria analysis.

The set of optimisation models can comprise a decision model based on an influence diagram.

The set of optimisation models can comprise a decision tree. For example, a decision tree model can be used for deciding whether to recommend an irregular immediate inspection or maintenance activity or to wait until the regular inspection. This can be based on at least one result of the condition monitoring step. An uncertainty of the result of the condition monitoring step can furthermore be integrated into the model.

The set of optimisation models can comprise a model based on a Markov decision process, such as a model based on a partially observable Markov decision process. A partially observable Markov decision process model can for example be used for jointly optimising the timing and type of inspection and maintenance activities or combinations thereof. This can for example also comprise optimising the timing of regular and/or irregular inspection activities and/or maintenance activities. An optional advantage can be for example that in such a model, knowledge of an effectivity of inspection and maintenance activities from other elements and from history of the represented element can be used. In another example or in a same case as discussed, a model based on a partially observable Markov decision process can be used to estimate a probability and at least one consequence of a failure of an element. Such consequences can for example be costs, a measure for resulting delays or another quantity relating to a risk of failure.

The set of optimisation models can comprise a partially observable Markov decision process.

The set of optimisation models can comprise a stochastic control process.

An element can be at least one of at least one component, at least one asset and at least one network. More specifically, an element of a railway infrastructure system can be at least one of the at least one component of the railway infrastructure system, at least one of the at least one asset of the railway infrastructure system and the at least one network of the railway infrastructure system, if said railway infrastructure system comprises a network.

Furthermore, an element can also be at least a portion of any of the respective component(s), asset(s) and/or network(s).

The invention is furthermore directed to a system. The system comprises the data processing system and at least one sensor configured to sense data relating to a represented railway infrastructure system or a portion thereof. The system is configured to carry out the method steps according to any of the preceding method embodiments.

The invention is furthermore directed to a computer program product comprising instructions, which, when the program is executed by the data processing system, cause the data processing system to perform the method steps according to any method embodiment.

Numbered Embodiments

Below, method embodiments will be discussed. These embodiments are abbreviated by the letter “M” followed by a number. Whenever reference is herein made to “method embodiments”, these embodiments are meant.
M1 A method,
   wherein the method comprises a data storing step that comprises storing data relating to a represented railway infrastructure system (1) by a data processing system,
   wherein the represented railway infrastructure system (1) comprises at least one component (4) and at least one asset (3).
M2 The method according to the preceding embodiment,
   wherein the represented railway infrastructure system (1) comprises furthermore at least one network (2).
M3 The method according to any of the preceding embodiments,
   wherein the method comprises furthermore at least one model evaluation step that comprises evaluating at least one model of at least one condition of at least a portion of the represented railway infrastructure system (1) by the data processing system.
M4 The method according to any of the preceding embodiments,
   wherein the method comprises a model generation step that comprises generating at least one model of at least one condition of at least a portion of the represented railway infrastructure system (1).
M5 The method according to any of the preceding method embodiments,
   wherein the method comprises furthermore
   a condition monitoring step that comprises estimating at least one condition (30) of the represented railway infrastructure system (1) at least by evaluating a set of monitoring models (11) by the data processing system.
M6 The method according to any of the preceding method embodiments,
   wherein the method comprises furthermore
   a predicting step that comprises predicting at least one condition (30) of said represented railway infrastructure system (1) at least by evaluating a set of prediction models (12) by the data processing system.
M7 The method according to any of the preceding method embodiments,
   wherein the method comprises furthermore
   a data quality estimation step that comprises estimating at least one quality of data regarding the represented railway infrastructure system (1) by the data processing system.
M8 The method according to any of the preceding method embodiments with the features of M5 and/or M6,
   wherein the method comprises furthermore
   a model validity estimation step that comprises estimating at least one validity of at least one result of evaluating at least one model of the set(s) of models (10) relating to the represented railway infrastructure system (1) by the data processing system.
M9 The method according to any of the preceding method embodiments,
   wherein the method comprises furthermore
   an optimisation step that comprises analysing and/or recommending at least one of inspection activities and maintenance activities for the represented railway infrastructure system (1) at least by evaluating a set of optimisation models (13) by the data processing system.
M10 The method according to any of the preceding method embodiments with the features of M9,
   wherein the method comprises performing maintenance activities and/or inspection activities according to results of the optimisation step.
M11 The method according to any of the preceding method embodiments, wherein the method is a method for monitoring an infrastructure system.
M12 The method according to any of the preceding method embodiments, wherein the method is a method for monitoring the represented railway infrastructure system (1).
M13 The method according to any of the preceding method embodiments, wherein the method is a method for monitoring at least one condition of the represented railway infrastructure system (1).
M14 The method according to any of the preceding method embodiments, wherein the method is a method for predicting at least one condition of the represented railway infrastructure system (1).
M15 The method according to any of the preceding method embodiments, wherein the method is a method for monitoring and predicting at least one condition of the represented railway infrastructure system (1).
M16 The method according to any of the preceding method embodiments with the features of M3,
   wherein at least one model that is evaluated in at least one of the at least one model evaluation step comprise furthermore
   stored data relating to other railway infrastructure systems (101) or parts thereof and/or stored data relating to the represented railway infrastructure system (1) or parts thereof.
M17 The method according to any of the preceding method embodiments with the features of M3,
   wherein at least one model that is evaluated in at least one of the at least one model evaluation step is a machine learning model.
M18 The method according to the preceding method embodiment,
   wherein at least one of the at least one machine learning model that is evaluated in the model evaluation step(s) comprises data relating to at least one element (5) of at least one of the other railway infrastructure systems (101) with similar properties to the modelled element (5).
M19 The method according to any of the preceding method embodiments with the features of M3,
   wherein at least one model that is evaluated in at least one of the at least one model evaluation step
   is a physics-based model representing at least one condition of an element (5) of the represented railway infrastructure system (1).
M20 The method according to any of the preceding method embodiments with the features of M4,
   wherein the model generation step comprises
   adapting at least one physics-based model representing at least one condition of at least one element (5) of the represented railway infrastructure system (1).
M21 The method according to any of the preceding method embodiments,
   wherein the data storing step comprises furthermore
   storing sensed data (21) that relate to at least one element (5) of the represented railway infrastructure system (1).
M22 The method according to any of the preceding method embodiments,
   wherein the data storing step comprises furthermore
   storing load data (22) that relate to a load of at least one element (5) of the represented railway infrastructure system (1).
M23 The method according to the preceding two method embodiments,
   wherein the step of storing load data (22) comprises estimating at least a part of the load data (22) based on the sensed data (21).
M24 The method according to any of the preceding method embodiments,
   wherein the data storing step comprises furthermore
   storing environment data (23) that relate to at least one property of an environment of at least one element (5) of the represented railway infrastructure system (1).
M25 The method according to any of the preceding method embodiments,
   wherein the data storing step comprises furthermore
   storing maintenance data (24) that relate to performed and/or possible maintenance activities of at least one element (5) of the represented railway infrastructure system (1).
M26 The method according to any of the preceding method embodiments,
   wherein the data storing step comprises furthermore
   storing inspection data (25) that relate to performed and/or possible inspection of at least one element (5) of the represented railway infrastructure system (1).
M27 The method according to any of the preceding method embodiments,
   wherein the data storing step comprises furthermore
   storing specification data (26) that relate to at least one property of at least one element (5) of the represented railway infrastructure system (1).
M28 The method according to any of the preceding method embodiments,
   wherein the data storing step comprises a data processing step.
M29 The method according to the preceding embodiment,
   wherein the data processing step comprises filtering data.
M30 The method according to the preceding embodiment,
   wherein filtering data comprises at least one of
   (a) removing and/or omitting data that do not match a data quality criterion,
   (b) applying a digital filter to the input data,
   (c) detecting, analysing and/or filtering a saturated signal, and
   (d) compressing data.
M31 The method according to any of the preceding method embodiments with the features of M5,
   wherein the condition monitoring step comprises at least one of a component condition monitoring step that comprises estimating at least one condition (30) of at least one of the at least one component (4) of the represented railway infrastructure system (1),
   an asset condition monitoring step that comprises estimating at least one condition (30) of at least one of the at least one asset (3) of the represented railway infrastructure system (1), and
   a network condition monitoring step that comprises estimating at least one condition (30) of at least one of the at least one network (2) of the represented railway infrastructure system (1).
M32 The method according to the preceding method embodiment,
   wherein the component condition monitoring step comprises
   estimating for at least one of the at least one component (4) at least one of a degradation, a type of the degradation, a severity of the degradation, a location of a damage, a location of a degraded portion of the at least one component, a type of a failure, a presence of an anomaly, a damage and a probability of a failure and thus generating degradation information.
M33 The method according to any of the preceding method embodiments with the features of M31,
   wherein the asset condition monitoring step comprises
   estimating for at least one of the at least one asset (3) at least one of a degradation, a type of the degradation, a severity of the degradation, a type of a failure, a presence of an anomaly, a remaining useful lifetime and a probability of a failure.
M34 The method according to any of the preceding method embodiments with the features of M31,
   wherein the asset condition monitoring step comprises
   using at least one condition (30) of at least one component (4) of each of the at least one of the at least one asset (3).
M35 The method according to any of the preceding method embodiments with the features of M31,
   wherein the asset condition monitoring step comprises
   combining at least two conditions (30) of at least one or a plurality of components (4) of the at least one of the at least one asset (3) of the railway infrastructure system (1).
M36 The method according to any of the preceding method embodiments with the features of M31,
   wherein the network condition monitoring step comprises
   combining data relating to at least one condition (30) of at least one asset (3) of the network (2).
M37 The method according to the preceding method embodiment,
   wherein the network condition monitoring step comprises
   combining data relating to at least one condition (30) of at least one asset (3) of the network (2) and data on at least one of a topology of the network (2) and operating rules of the network (2).
M38 The method according to any of the preceding method embodiments with the features of M31,
   wherein the set of monitoring models (11) comprises at least one model based on a time-series analysis.
M39 The method according to any of the preceding method embodiments with the features of M31,
   wherein the set of monitoring models (11) comprises at least one data-driven model.
M40 The method according to any of the preceding method embodiments with the features of M31,
   wherein the set of monitoring models (11) comprises at least one supervised machine learning model.
M41 The method according to any of the preceding method embodiments with the features of M31,
   wherein the set of monitoring models (11) comprises at least one unsupervised machine learning model.
M42 The method according to any of the preceding method embodiments with the features of M31,
   wherein the set of monitoring models (11) comprises at least one reinforcement learning model.
M43 The method according to any of the preceding method embodiments with the features of M31,
   wherein the set of monitoring models (11) comprises at least one model based on a regression analysis.
M44 The method according to any of the preceding method embodiments with the features of M31,
   wherein the set of monitoring models (11) comprises at least one physics-based model.
M45 The method according to the preceding method embodiment,
   wherein the set of monitoring models (11) comprises at least one model based on a break-point detection method.
M46 The method according to any of the two preceding method embodiments,
   wherein the set of monitoring models (11) comprises at least one physical structural-dynamics model.
M47 The method according to any of the preceding method embodiments with the features of M31 and M3,
   wherein the condition monitoring step comprises at least one of the at least one model evaluation step.
M48 The method according to any of the preceding method embodiments with the features of M6,
   wherein the predicting step comprises
   estimating at least one of a point estimate and limits of an interval related to the development of a quantity relating to a condition (30) of an element (5) in future.
M49 The method according to the preceding method embodiment,
   wherein the limits of the interval related to the development of the quantity are confidence limits of said interval.
M50 The method according to any of the two preceding method embodiments,
   wherein the predicting step comprises estimating characterising values of a prediction model of the set of prediction models (12) representing the development of the quantity relating to the degradation of the element in future and thus generating at least one degradation estimation with uncertainty quantification.
M51 The method according to any of the preceding method embodiments with the features of M6,
   wherein the predicting step comprises evaluating a prediction model of the set of prediction models (12) representing the development of a quantity relating to a degradation of an element (5) in future,
   wherein said prediction model represents the development at at least one point of time in future, preferably a plurality of points of time in future and still more preferably an interval of time in future.
M52 The method according to the two preceding embodiments,
   wherein the respective prediction models are the same prediction model.
M53 The method according to any of the preceding method embodiments with the features of M6,
   wherein the predicting step comprises
   predicting for at least one element (5) of the represented railway infrastructure system (1) at least one of a degradation, a type of the degradation, a severity of the degradation, a type of a failure, a presence of an anomaly, a remaining useful lifetime, a performance and a probability of a failure, and thus generating prediction information for the at least one element (5).
M54 The method according to any of the preceding method embodiments with the features of M6,
   wherein at least one model of the set of prediction models (12) that represents a condition (30) of an element (5) of the represented railway infrastructure system (1) is obtained from or updated with data relating to said condition (30) of the element.
M55 The method according to any of the preceding method embodiments with the features of M6,
   wherein at least one model of the set of prediction models (12) that represents a condition (30) of an element (5) of the represented railway infrastructure system (1) is obtained from or updated with data relating to a corresponding condition (30) of at least one other element (5) of a corresponding type.
M56 The method according to any of the preceding embodiments with the features of M6,
   wherein the set of prediction models (12) comprises at least one model that represents a future development of at least one condition (30) of an element (5) of the represented railway infrastructure system (1) as a function of at least cyclic loads of the element (5).
M57 The method according to any of the preceding embodiments with the features of M6,
   wherein the set of prediction models (12) comprises at least one model that represents a future development of at least one condition (30) of an element (5) of the represented railway infrastructure system (1) as a function of time.
M58 The method according to any of the preceding method embodiments with the features of M48 and M3,
   wherein the predicting step comprises at least one of the at least one model evaluation step.
M59 The method according to any of the preceding embodiments with the features of M6,
   wherein the predicting step comprises at least one of a component predicting step that comprises predicting at least one condition of at least one of the component(s) (4) of the represented railway infrastructure system (1),
   an asset predicting step that comprises predicting at least one condition of at least one of the asset(s) (3) of the represented railway infrastructure system (1), and
   a network predicting step that comprises predicting at least one condition of at least one of the network(s) (2) of the represented railway infrastructure system (1).
M60 The method according to the preceding embodiment,
   wherein the component predicting step comprises
   evaluating at least one model from the set of prediction models (12),
   wherein the at least one model represents a future development of at least one of the at least one condition of the component (4) as a function of data of at least one data type selected from sensed data, load data, environment data,
   maintenance data, and specification data,
   wherein the data of the at least one data type relate to the component (4) or to an asset (3) that comprises the component (4).
M61 The method according to any of the preceding method embodiments with the features of M59,
   wherein the component predicting step comprises evaluating a physical deterioration model.
M62 The method according to any of the preceding method embodiments with the features of M59,
   wherein the component predicting step comprises evaluating a statistical deterioration model.
M63 The method according to any of the preceding method embodiments with the features of M59 and M21,
   wherein the component predicting step comprises utilising at least one type of sensed data (21) to evaluate at least one model of the set of prediction models (12).
M64 The method according to any of the preceding method embodiments with the features of M59,
   wherein the asset predicting step comprises
   combining results of at least one component predicting step for at least one component (4) of the asset (3).
M65 The method according to any of the preceding method embodiments with the features of M59,
   wherein the network predicting step comprises
   predicting an availability of at least one route in the at least one network (2) at a future point in time.
M66 The method according to any of the preceding method embodiments with the features of M59,
   wherein the network predicting step comprises
   predicting a capacity of at least one route in the at least one network (2) at a future point in time.
M67 The method according to any of the preceding method embodiments with the features of M59,
   wherein the predicting step comprises predicting the condition of at least two elements (5) of the network (2), such as by performing at least one of the component predicting step and the asset predicting step,
   and wherein the network predicting step comprises combining the predicted conditions of the at least two elements (5) with the topology and/or operating rules of the network (2).
M68 The method according to any of the preceding method embodiments with the features of M6,
   wherein the set of prediction models (12) comprises at least one model based on a time-series analysis.
M69 The method according to any of the preceding method embodiments with the features of M6,
   wherein the set of prediction models (12) comprises at least one model based on a regression analysis.
M70 The method according to any of the preceding method embodiments with the features of M6,
   wherein the set of prediction models (12) comprises at least one model based on random processes.
M71 The method according to any of the preceding method embodiments with the features of M6,
   wherein the set of prediction models (12) comprises at least one supervised or unsupervised machine learning model.
M72 The method according to any of the preceding method embodiments with the features of M6,
   wherein the set of prediction models (12) comprises at least one physical deterioration model.
M73 The method according to any of the preceding method embodiments with the features of M6,
   wherein the set of prediction models (12) comprises at least one survival model.
M74 The method according to any of the preceding method embodiments with the features of M8,
   wherein the model validity estimation step comprises estimating a quantified property of the at least one result of evaluating the at least one model of the set of models (10), such as a measure for an error, a variance or a bias of at least one model.
M75 The method according to any of the preceding method embodiments with the features of M7,
   wherein data quality estimation step comprises estimating at least one of the at least one quality of at least one of sensed data (21), load data (22), environment data (23), maintenance data (24), inspection data (25) and specification data (26) according to any of the preceding embodiments that comprise the respective data.
M76 The method according to any of the preceding embodiments with the features of M9,
   wherein the optimisation step comprises
   recommending at least one of a type and a timing of at least one of the inspection activities and the maintenance activities for at least one element (5) of the represented railway infrastructure system (1).
M77 The method according to any of the preceding embodiments with the features of M9,
   wherein the optimisation step comprises
   recommending an order of the inspection activities and/or the maintenance activities.
M78 The method according to any of the preceding embodiments with the features of M9,
   wherein the optimisation step comprises
   recommending resources for at least one of the inspection activities and the maintenance activities.
M79 The method according to the preceding method embodiment,
   wherein recommending resources comprises at least one of (a) recommending inspection resources for the inspection activities and (b) recommending maintenance resources for the maintenance activities.
M80 The method according to any of the preceding embodiments with the features of M9,
   wherein the optimisation step comprises
   representing at least one activity of the inspection activities and/or the maintenance activities for at least one element (5) of the represented railway infrastructure system (1) by at least one model of the set of optimisation models (13).
M81 The method according to any of the preceding embodiments with the features of M9,
   wherein the optimisation step comprises representing for at least one or each of the maintenance activities at least one of
   (a) a possible influence or possible influences on the respective element (5),
   (b) a possible influence on at least one other element (5),
   (c) a need of resources,
   (d) an uncertainty of an influence of the maintenance activity, and
   (e) a degradation, a degradation process or a failure that the maintenance activity may influence,
   by at least one model of the set of optimisation models (13).
M82 The method according to any of the two preceding embodiments and with the features of M7 and M8,
   wherein the optimisation step comprises representing for at least one or each of the inspection activities at least one of
   (a) a possible influence on a quality of data relating to the respective element (5),
   (b) a possible influence on a validity of at least one result of evaluating a model of a set of models (10) relating to the element (5),
   (c) a possible influence on the respective element (5),
   (d) a possible influence on at least one other element (5),
   (e) a need of resources, and
   (f) a degradation, a degradation process or a failure that the inspection activity may reveal,
   by at least one model of the set of optimisation models (13).
M83 The method according to any of the preceding four embodiments and with the features of M2,
   wherein the optimisation step comprises
   estimating an impact of at least one activity from the inspection activities and the maintenance activities on an availability of at least one route in the at least one network (2) by combining their impact on the respective elements (5) of the represented railway infrastructure system (1) with a topology and/or operating rules of the network (2).
M84 The method according to any of the preceding embodiments with the features of M9,
   wherein the optimisation step comprises representing performed activities of the at least one of the inspection activities and the maintenance activities and/or representing at least one or a plurality of impact(s) of said performed activities.
M85 The method according to any of the preceding embodiments with the features of M9,
   wherein the optimisation step comprises estimating for each of a plurality of combinations of activities from the at least one of the inspection activities and maintenance activities at least one possible outcome.
M86 The method according to any of the three preceding method embodiments,
   wherein the optimisation step comprises furthermore
   estimating at least one other influence and/or impact of each of the combinations of activities, wherein said at least one other influence and/or impact is represented for at least one of the activities by at least one model of the set of optimisation models (13).
M87 The method according to any of the preceding two embodiments,
   wherein the optimisation step comprises furthermore selecting at least one combination of activities from the plurality of combinations of activities based on an optimization criterion.
M88 The method according to the preceding embodiment,
   wherein the optimisation step comprises furthermore applying a set of at least one or a plurality of further constraints.
M89 The method according to any of the preceding embodiments with the features of M85,
   wherein the optimisation step comprises
   using at least one result of the predicting step,
   wherein the predicting step is according to embodiment M4 or any of its depending embodiments.
M90 The method according to the preceding method embodiment,
   wherein the optimisation step comprises furthermore
   using prediction information for at least one element (5) of the represented railway infrastructure system (1),
   wherein said prediction information is according to the preceding embodiment M4.5 or any of its depending embodiments.
M91 The method according to any of the preceding embodiments with the features of M85 and M3,
   wherein the optimisation step comprises at least one of the at least one model evaluation step
M92 The method according to any of the preceding embodiments with the features of M85,
   wherein the set of optimisation models (13) comprises at least one of
   (a) a model based on a cost benefit analysis,
   (b) a model based on utility analysis, and
   (c) a model based on a multi-criteria analysis.
M93 The method according to any of the preceding embodiments with the features of M85,
   wherein the set of optimisation models (13) comprises a decision model based on an influence diagram.
M94 The method according to any of the preceding embodiments with the features of M85,
   wherein the set of optimisation models (13) comprises a decision tree.
M95 The method according to any of the preceding embodiments with the features of M85,
   wherein the set of optimisation models (13) comprises a Markov decision process.
M96 The method according to any of the preceding embodiments with the features of M85,
   wherein the set of optimisation models (13) comprises a partially observable Markov decision process.
M97 The method according to any of the preceding embodiments with the features of M85,
   wherein the set of optimisation models (13) comprises a stochastic control process.
M98 The method according to any of the preceding method embodiments that comprise at least one element (5),
   wherein each element (5) is at least one of at least one component (4), at least one asset (3) and at least one network (2).
M99 The method according to any of the preceding method embodiments but the last that comprise at least one element (5),
   wherein each element (5) is at least one of at least one component (4), at least one asset (3), at least one network (2) and at least portion of any of the aforementioned.

Below, system embodiments will be discussed. These embodiments are abbreviated by the letter “S” followed by a number. When reference is herein made to a system embodiment, those embodiments are meant.
S1 A system comprising at least one data processing system and at least one sensor configured to sense data relating to a represented railway infrastructure system (1) or a portion thereof,
   wherein the system is configured to carry out the method steps according to any of the preceding method embodiments.

Below, computer program product embodiments will be discussed. These embodiments are abbreviated by the letter “P” followed by a number. Whenever reference is herein made to “program embodiments”, these embodiments are meant.
P1 A computer program product comprising instructions, which, when the program is executed by the data processing system,
   cause the data processing system to perform the method steps according to any method embodiment.

Whenever a relative term, such as “about”, “substantially” or “approximately” is used in this specification, such a term should also be construed to also include the exact term. That is, e.g., “substantially straight” should be construed to also include “(exactly) straight”.

Whenever steps are recited in the appended claims, it should be noted that the order in which the steps are recited in this text may be the preferred order, but it may not be mandatory to carry out the steps in the recited order. That is, unless otherwise specified or unless clear to the skilled person, the orders in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

### FIGURES

FIG. 1 shows a represented railway infrastructure system and its relation to other railway infrastructure systems.

FIG. 2 shows the represented railway infrastructure system and a data storing step.

FIG. 3 shows an example of a component, sensed data and estimating a condition.

FIG. 4 shows an example of a result of a condition monitoring step.

FIG. 5 shows an example of a result of a predicting step.

FIG. 6 shows some steps and input data of the method.

FIG. 7 shows possible details of possible input data.

FIG. 8 shows an example of a feature extraction step.

FIG. 9 shows an example of a condition of an element.

FIG. 10 shows an example of representation and/or processing of maintenance events by the method.

FIG. 11 shows an example of a data-processing system.

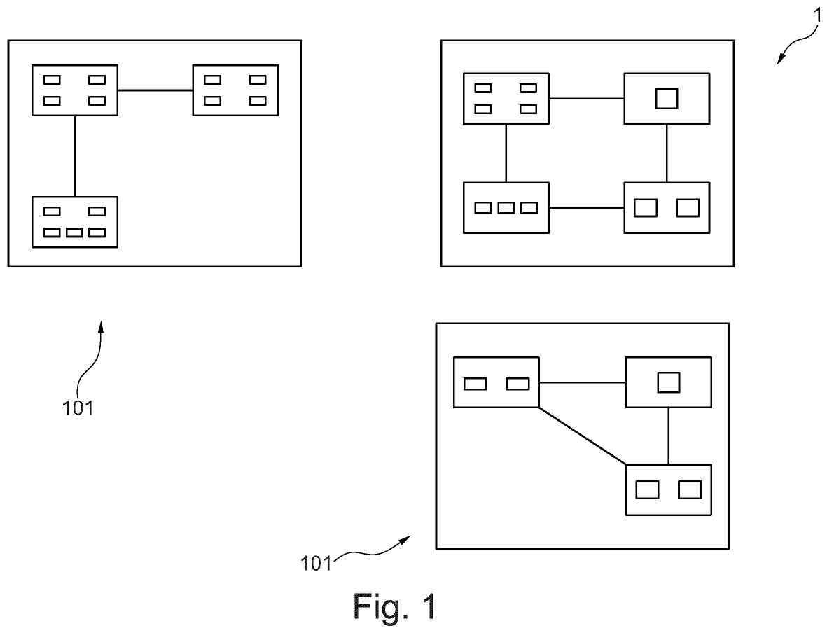

FIG. 1 shows a represented railway infrastructure system 1 that comprises a network 2 comprising assets 3 that each comprise at least one component 4. The number of the assets as well as the number of the components that the assets respectively comprise is merely exemplary. The network comprises furthermore connections or routes between the assets. Those routes can for example correspond to railway connections within the network of the represented railway infrastructure system 1. FIG. 1 shows furthermore two other railway infrastructure systems 101 that also comprise assets 3 which each comprise at least one component 4. For the sake of an example, taking the number of components 4 per asset 3 as indicator for a type of the respective asset 3, at least some of the other railway infrastructure systems 101 comprise assets 3 of a same type as in the represented railway infrastructure system 1. The type of assets 3 that the railway infrastructure systems have in common does not need to be the same for each pair of railway infrastructure systems. That is, the represented railway infrastructure system 1 and a first other railway infrastructure system 101 can both comprise same assets, such as switches, of a same type A. The represented railway infrastructure system 1 and a second railway infrastructure system 101 can both comprise same assets of a different type, such as rails of a type B. The same consideration is applicable for components 4 of assets 3. The same type A or B is not limited to a model name of an asset, but it can also refer to a technical type, and it can be still more precise, e.g. if type A refers to a version of switches that are in use for 10 years and type B refers to the same type of switches, wherein those where mounted later, so that they are for example only in use for 5 years.

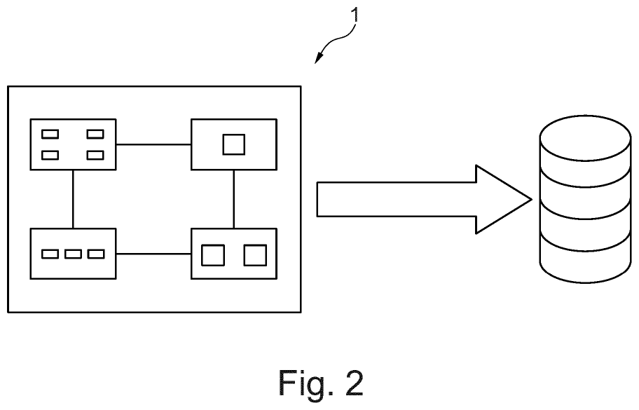

FIG. 2 shows an example of a step of sensing data and a step of storing sensed data relating to the represented railway infrastructure system 1. A method comprises sensing data relating to the represented railway infrastructure system 1, or more particularly to at least one of its assets and/or components. The data are transmitted and at least temporarily stored. The same method or method step can be performed for at least one of the other railway infrastructure systems 101.

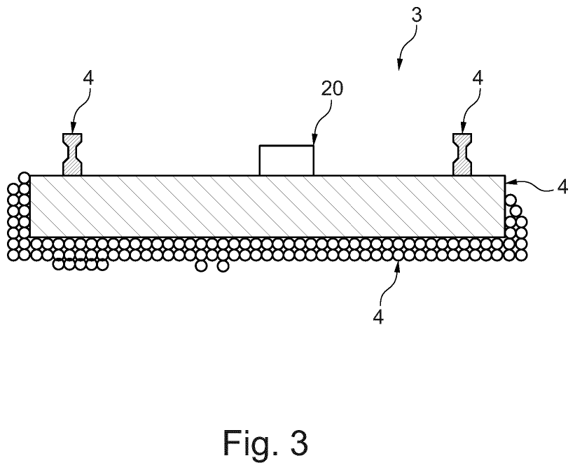

FIG. 3 shows an example of an asset 3 with at least one sensor 20. The position of the at least one sensor 20 is to be understood as an example for sensor(s) 20 capturing data relating to the asset 3 or one or more components 4 thereof. In FIG. 3, the at least one sensor 20 is one acceleration sensor. In this specific example, two components 4 of the asset 3 are rails, and one component 4 is a sleeper. Furthermore, a trackbed under the sleeper is shown as further example of a further component 4.

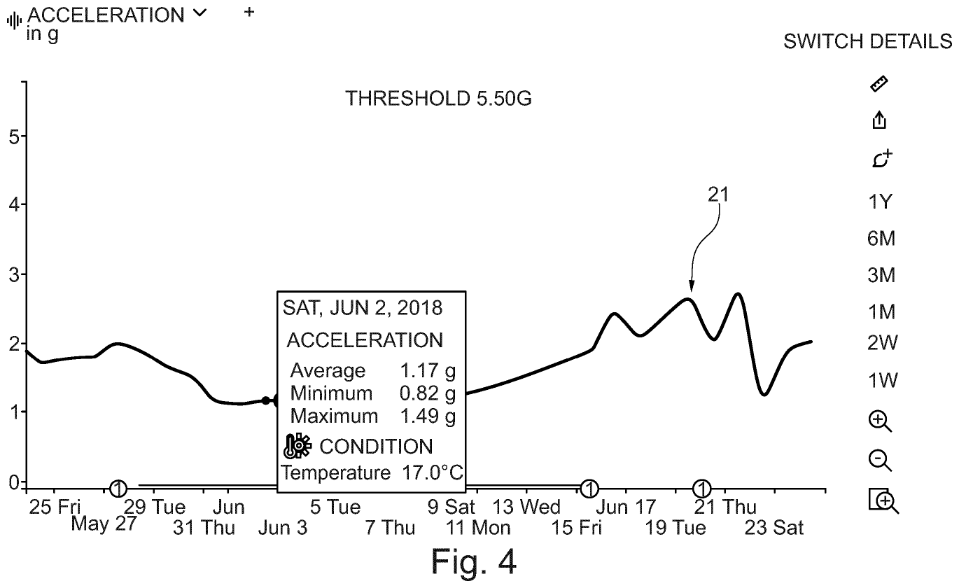

FIG. 4 shows an example of a result of a data storing step for sensed data 21 from an asset 3 or a component 4. The data storing step comprises storing timestamped acceleration data at least temporarily as an example for sensed data 21 from a switch as an example for an asset 3 or a component 4. Independently from the types of the sensed data 21 and the asset 3 or a portion thereof to which the sensed data 21 relate, the sensed data 21 can then be processed, e.g. an average, minimum and maximum value can be calculated for intervals of time, such as days or hours, and can be stored and/or used for subsequent processing steps.

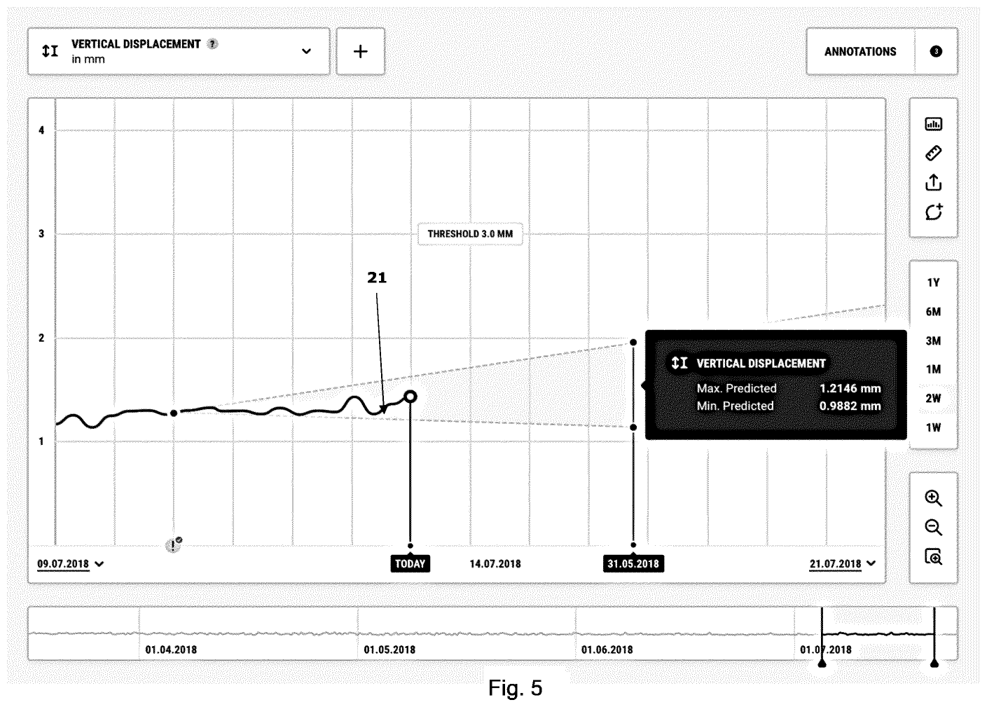

FIG. 5 shows an example of a result of a condition monitoring step and a predicting step for trackbed conditions as an example, wherein the trackbed is a component 4 of an asset 3. A health of the trackbed is monitored through a vertical displacement of a sleeper under passing trains, which reflects how well the sleeper is supported by the trackbed. (An unhealthy trackbed provides a poor support which leads to higher vertical displacement and/or to a higher deflection in general). The condition monitoring step can comprise the above-mentioned data storing step as well as a data processing step and a time-domain analysis of time-series data. FIG. 5 shows a plot of processed data from the data processing step (mean daily vertical displacement observed on a selected asset and a measurement location). Furthermore, the plot shows a prediction of limits of an evolution of said vertical displacement in future. The prediction can be performed by estimating an interval representing a lower and upper estimate of the mean daily displacement in future. Said prediction can be performed for a fixed period, such as each day in a period of 90 days after the last data relating to the trackbed were recorded.

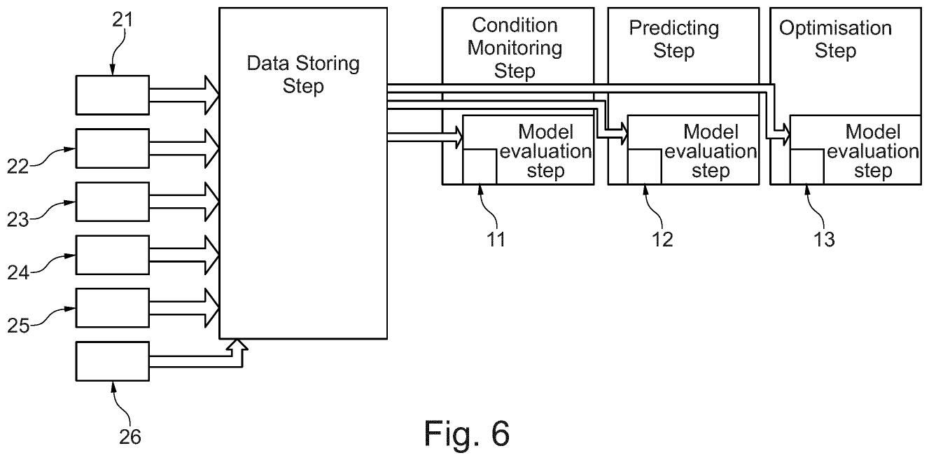

FIG. 6 shows an example of the method. The method can be an at least partially computer-implemented method. In FIG. 6, the method comprises a data storing step, a condition monitoring step, a predicting step and an optimisation step. The method can comprise further steps, such as a data quality estimation step and/or a model validity estimation step. The data storing step can comprise storing sensed data 21 from at least one sensor 20, and optionally at least one of load data 22, environment data 23, maintenance data 24 and inspection data 25. The data storing step can further comprise storing specification data 26. Each of the condition monitoring step, the predicting step and/or the optimisation step can use at least a part of the data that is stored in the data storing step. The condition monitoring step can comprise evaluating a set of monitoring models 11. This can be performed in a model evaluation step. The part of the stored data that is used in the condition monitoring step can be corresponding at least to input values of the set of monitoring models. The condition monitoring step can also use further data, such as data from another method step, such as from the data quality estimation step.

Analogously, the predicting step can comprise evaluating a set of prediction models 12, wherein the set of prediction models can optionally be evaluated in a model evaluation step that the predicting step can comprise. Respectively, the part of the stored data that is used can correspond at least to input data of the set of prediction models 12. Furthermore, results from the condition monitoring step or other method steps can optionally be used in the predicting step, for example as supplementary input data for the set of prediction models.

The optimisation step can comprise evaluating a set of optimisation models 13, wherein the set of optimisation models 13 can optionally be evaluated in a model evaluation step that the optimisation step comprises. The part of the stored data that is used can correspond to input data of the set of optimisation models 13. Results of the condition monitoring step and/or the predicting step as well as of other method steps can optionally also be used in the optimisation step. At least some or all of the method steps can be performed by a data processing system. In particular, the model evaluation steps and/or a transmission of data, such as sensed or stored data, can be performed by the data processing system. However, inspection 25 data and/or maintenance data 24 can optionally be manually or automatically inputted.

Optionally, an effect of the condition monitoring step can be an estimation of at least one condition of an element 5 of a railway infrastructure system 1 without human inspection or with less human inspection. An optional effect of the predicting step can be an estimation of when an element will fail, that is, of its remaining useful lifetime. Such an information can be optionally advantageous for a maintenance engineer in a maintenance decision. An optional effect of the optimisation step can be an optimised recommendation of maintenance and/or inspection activities that lead to less needed resources and/or lower negative impacts on reliability, availability and/or performance of the represented railway infrastructure system.

The method can furthermore comprise a part that is not computer-implemented, for example performing inspection activities and/or maintenance activities according to a result of the optimisation step.

At least one, a plurality or all of the sets of models 10, 11, 12, 13 can be generated by an engineer and/or another person skilled in the art. They can be input data of the method. At least the generation of at least one models can also be at least partially automatically. At least some steps of the generation of at least one model can optionally be automated, such as an integration into the method. The model generation step can also be a part of the method.

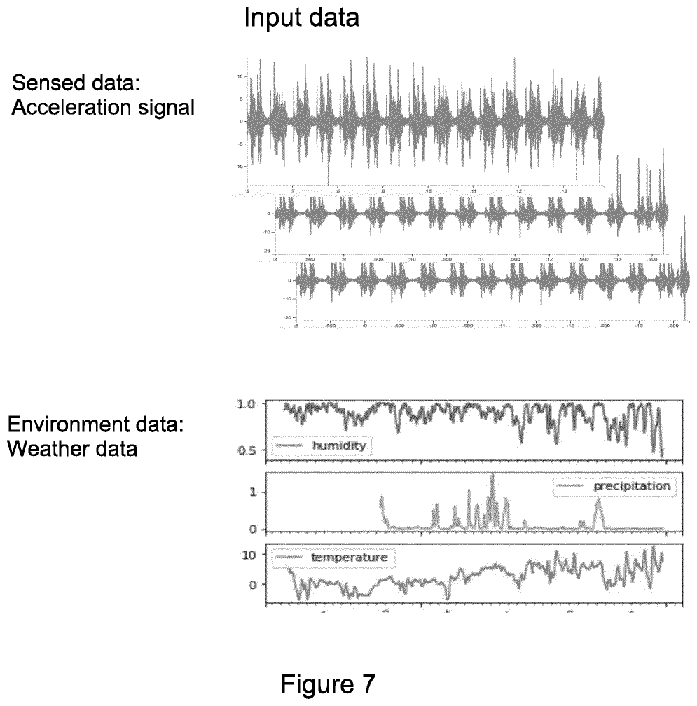

FIG. 6 shows an example of the data storing step, a model generation step and the condition monitoring step comprising a model evaluation step, all of them performed for a degradation of a frog as example of a condition of a component 4 or a part thereof. The degradation can for example be a degradation of a profile of the frog, such as wear or plastic deformation. The degradation can for example also be surface fatigue degradation, such as head checks. The data storing step can optionally comprise storing acceleration data relating to the frog (or another component 4 respectively). Optionally, sensed environment data 23 can be stored in the data storing step. Said environment data can be weather data, such as measures of temperature, humidity and precipitation, as shown in FIG. 7. As stated above, the frog is as an example of a component 4 of an asset 3, wherein the asset 3 can be a railway switch.

The model generation step can comprise using the stored acceleration data that are relating to the frog as an example of a component 4 of the railway infrastructure system 1. The stored data can for example be interpreted as time-series. Multiple features can be extracted performing time- and frequency domain analyses of the time series. At least one set of models 10 that comprises at least one model is then generated. In this example, a set of monitoring models 11 is generated, wherein this set of monitoring models 11 comprises a machine learning model that is trained to estimate a health indicator of the frog. The health indicator can be a function of the extracted features. The health indicator can be a unitless measure. The health indicator is an indicator for a health condition of the frog, for example having the value 1 when the respective element is brand-new and 0 when it failed. The health indicator can be a part of a condition 30 of the frog or it can be interpreted as an (overall) condition of the frog. That is, the health condition can be a condition 30 of the respective component 4 or asset 3, or at least a part of such a condition, for example a part of a condition of an asset 3, such as a switch, that comprises a component 4, such as the frog.

The condition monitoring step comprises monitoring at least said condition 30 of said component 4 based on the set of models generated during the model generation step. That is, the sensed data 21 and further data 22, 23, 24, 25, such as the environment data 23 in this example, are used to evaluate the model(s) in the set of monitoring models 11. A result of evaluating the set of monitoring models 11 is an estimation of at least one condition of said component 4, in this case the health indicator. The condition monitoring step can optionally further comprise a post-processing, combining, agglomerating and/or analysing of the estimated condition(s). In this example, the health indicator can furthermore be transformed to a health status indicating an overall state of the component 4 or a respective asset 3 on a discrete scale, for example when conditions or data from several components 4 are agglomerated.

FIGS. 7, 8 and 9 illustrate the condition monitoring and data storing step for the frog as example of a component of an asset.

FIG. 7 shows examples of input data, comprising the sensed data 21, such as the acceleration signal, and/or the environment data 23, such as air humidity, temperature and/or precipitation.

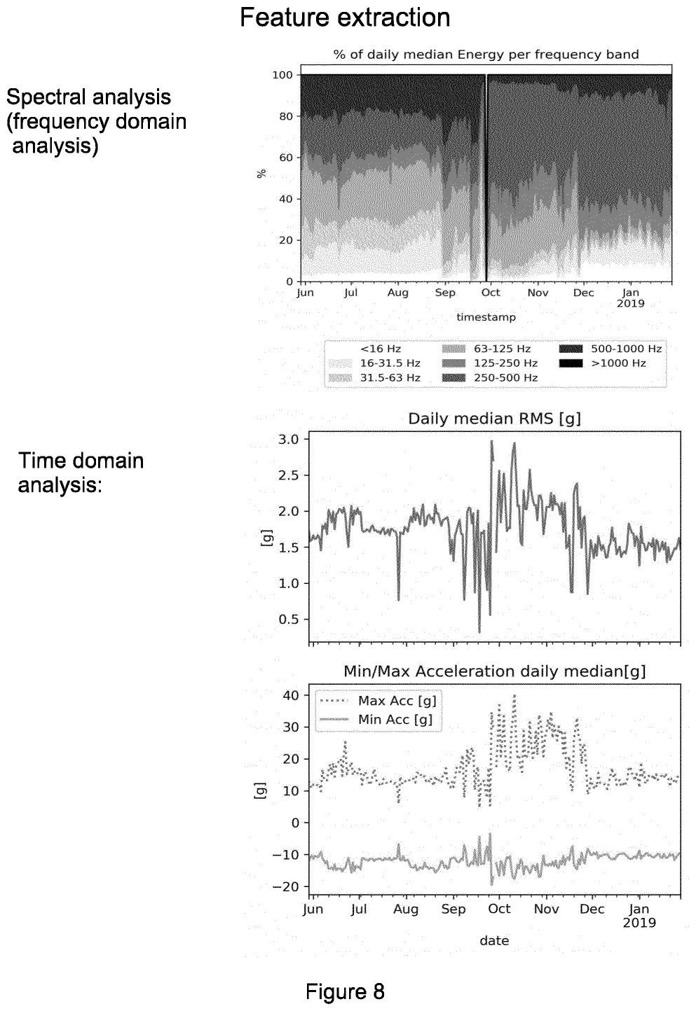

FIG. 8 illustrates an optional embodiment of one of the model generation steps, comprising feature engineering, that is, extracting features from at least a portion of the input data. In this example, the sensed data 21 are again comprising the acceleration data. This model generation step comprises analysing an acceleration signal corresponding to the acceleration data in at least one of the time-domain and the frequency-domain.

In the time-domain, features such as RMS (Root Mean Squared), minimum, maximum and/or different quantiles are extracted from the acceleration signal. In the frequency domain, an energy of the acceleration signal in different frequency bands is calculated. The features can then be used as input of data or for the generation of a machine learning model and/or an artificial intelligence model belonging to at least one of the sets of models 10, such as the set of monitoring models 11. An output of the model can be the health indicator.

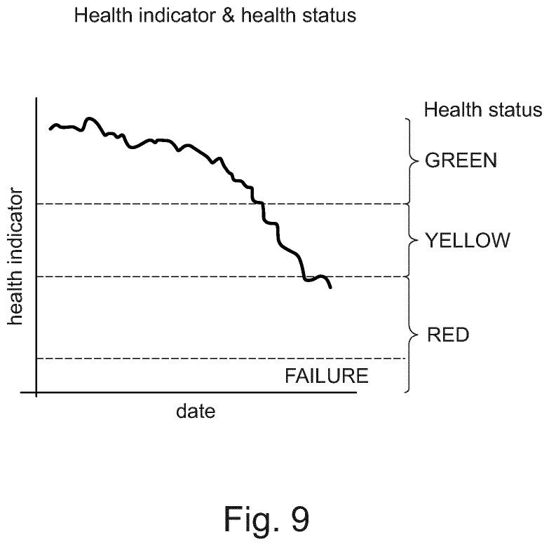

FIG. 9 details an example of the health indicator. The health indicator can be a continuous variable, which represents the health of a monitored element 5, in this case of said abovementioned component 4, the frog. A certain defined value of the health indicator represents a health and/or a degradation of the component that is considered to be inacceptable, e.g. safety critical, and has impact on the availability of said element and/or an 3 asset to which said element belongs, e.g. said switch to which the frog belongs. From the health indicator, there can furthermore a health status be derived. The health status can be a categorical (discrete) variable that represents the health of the component, in this case said frog. The health status can for example take three categorical values associated to different colours. An optional advantage can be a better perception by the user.

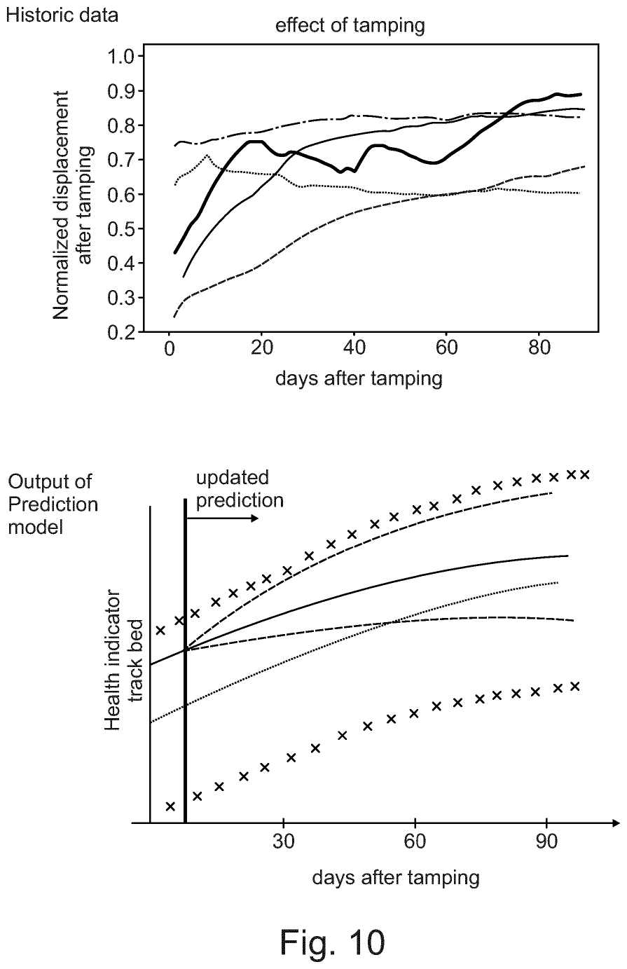

FIG. 10 shows a prediction of the health of the track bed, as example for the health of a component 4 or an asset 3, after a maintenance event, in this case after tamping of the track bed.

The upper diagram shows selected historic data that are used for generating a prediction model of the set of prediction models 12. Said selected historic data demonstrate a normalised effect of tamping on the vertical displacement, which can be used as health indicator of the track bed and/or of at least one of its conditions.

The lower diagram shows a result of a prediction by a model of the set of prediction models 12, in this case by a Bayesian model that was trained with the historic data that are shown in the upper diagram. In the lower diagram, a mean prediction of said model of the set of prediction models 12 is indicated by a solid, non-vertical line. Confidence bounds that represent an uncertainty of such a prediction are indicated by dashed lines in the same diagram.

A dotted line and lines indicated by crosses in the lower diagram show a prediction which is generated from data from the day when the tamping occurs. (The tamping can also be detected at a later point in time if the data of the day when the tamping occurs are only processed at said later point in time.) The tamping can optionally be detected by at least one of external maintenance data, such as the maintenance data 24, and the sensed data 21. The vertical solid line shows how the prediction is updated with some, for example 5 days of data and/or measurements after the tamping event. An optional advantage of said updating is that with the new data and/or measurements, the uncertainty of the prediction can be significantly reduced.

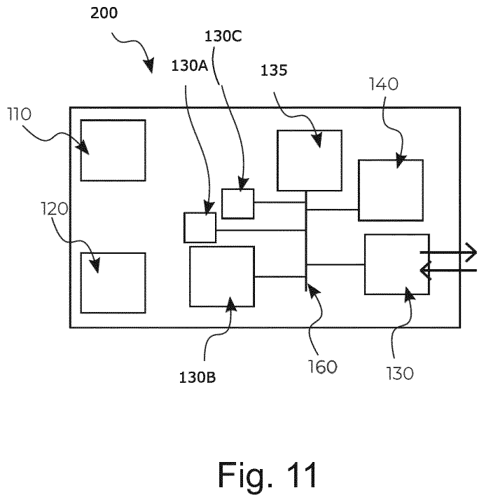

FIG. 11 provides a schematic of a data-processing system 200. This data-processing system 200 can be part of a data-processing system or can constitute the data-processing system.

The data-processing system 200 may comprise a computing unit 135, a first data storage unit 130A, a second data storage unit 130B and a third data storage unit 130C.

The data-processing system 200 can be a single data-processing system or an assembly of data-processing systems. The data-processing system 200 can be locally arranged or remotely, such as a cloud solution.

On the different data storage units 130, different data can be stored.

Additional data storage can be also provided and/or the ones mentioned before can be combined at least in part.

The computing unit 135 can access the first data storage unit 130A, the second data storage unit 130B and the third data storage unit 130C through the internal communication channel 160, which can comprise a bus connection 160.

The computing unit 130 may be single processor or a plurality of processors, and may be, but not limited to, a CPU (central processing unit), GPU (graphical processing unit), DSP (digital signal processor), APU (accelerator processing unit), ASIC (application-specific integrated circuit), ASIP (application-specific instruction-set processor) or FPGA (field programable gate array). The first data storage unit 130A may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM).

The second data storage unit 130B may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM).

The third data storage unit 130C may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM).

The data-processing system 200 may comprise a further memory component 140 which may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM). The memory component 140 may also be connected with the other components of the data-processing system 200 (such as the computing component 135) through the internal communication channel 160.

In addition, the data-processing system 200 may comprise an input user interface 110 which can allow the user of the data-processing system 200 to provide at least one input (e.g. instruction) to the data-processing system 200. For example, the input user interface 110 may comprise a button, keyboard, trackpad, mouse, touchscreen, joystick and the like.

Additionally, still, the data-processing system 200 may comprise an output user interface 120 which can allow the data-processing system 200 to provide indications to the user. For example, the output user interface 110 may be a LED, a display, a speaker and the like.

The output and the input user interface 110 may also be connected through the internal communication component 160 with the internal component of the device 200.

The processor may be singular or plural, and may be, but not limited to, a CPU, GPU, DSP, APU, or FPGA. The memory may be singular or plural, and may be, but not limited to, being volatile or non-volatile, such an SDRAM, DRAM, SRAM, Flash Memory, MRAM, F- RAM, or P-RAM.

The data processing device can comprise means of data processing, such as, processor units, hardware accelerators and/or microcontrollers. The data processing device 20 can comprise memory components, such as, main memory (e.g. RAM), cache memory (e.g. SRAM) and/or secondary memory (e.g. HDD, SDD). The data processing device can comprise busses configured to facilitate data exchange between components of the data processing device, such as, the communication between the memory components and the processing components. The data processing device can comprise network interface cards that can be configured to connect the data processing device to a network, such as, to the Internet. The data processing device can comprise user interfaces, such as:
output user interface, such as:
   screens or monitors configured to display visual data (e.g. displaying graphical user interfaces of the questionnaire to the user),
   speakers configured to communicate audio data (e.g. playing audio data to the user),
input user interface, such as:
   camera configured to capture visual data (e.g. capturing images and/or videos of the user),
   microphone configured to capture audio data (e.g. recording audio from the user),
   keyboard configured to allow the insertion of text and/or other keyboard commands (e.g. allowing the user to enter text data and/or other keyboard commands by having the user type on the keyboard) and/or trackpad, mouse, touchscreen, joystick — configured to facilitate the navigation through different graphical user interfaces of the questionnaire.

The data processing device can be a processing unit configured to carry out instructions of a program. The data processing device can be a system-on-chip comprising processing units, memory components and busses. The data processing device can be a personal computer, a laptop, a pocket computer, a smartphone, a tablet computer. The data processing device can be a server, either local and/or remote. The data processing device can be a processing unit or a system-on-chip that can be interfaced with a personal computer, a laptop, a pocket computer, a smartphone, a tablet computer and/or user interface (such as the upper-mentioned user interfaces).

### Numbered References

1 represented railway infrastructure system
2 network
3 asset
4 component
5 element
10 set of models
11 set of monitoring models
12 set of prediction models
13 set of optimisation models
20 sensor
21 sensed data
22 load data
23 environment data
24 maintenance data
25 inspection data
26 specification data
30 condition
101 other railway infrastructure system

1. A method, wherein the method comprises
a data storing step that comprises storing data relating to a represented railway infrastructure system by a data processing system,
a condition monitoring step that comprises estimating at least one condition of the represented railway infrastructure system least by evaluating a set of monitoring models by the data processing system,
a predicting step that comprises predicting at least one condition of said represented railway infrastructure system at least by evaluating a set of prediction models by the data processing system, and
at least one model evaluation step that comprises evaluating at least one model of at least one condition of at least a portion of the represented railway infrastructure system by the data processing system, and
wherein the represented railway infrastructure system comprises at least one component at least one asset.

2. The method according to claim 1, wherein the method comprises furthermore an optimisation step that comprises at least one of analysing and recommending at least one of inspection activities and maintenance activities for the represented railway infrastructure system at least by evaluating a set of optimisation models by the data processing system.

3. The method according to claim 1, wherein the represented railway infrastructure system comprises furthermore at least one network.

4. The method according to claim 1, wherein the data storing step comprises furthermore at least one of
storing sensed data that relate to at least one element of the represented railway infrastructure system,
storing load data that relate to a load of at least one element of the represented railway infrastructure system,
storing environment data that relate to at least one property of an environment of at least one element of the represented railway infrastructure system, and
a data processing step that comprises filtering data.

5. The method according to claim 1, wherein the data storing step comprises furthermore at least one of
storing maintenance data that relate to performed and possible maintenance activities of at least one element of the represented railway infrastructure system, and
storing inspection data that relate to performed and possible inspection of at least one element of the represented railway infrastructure system.

6. The method according to claim 1, wherein the condition monitoring step comprises at least one of the at least one model evaluation step and at least one of
a component condition monitoring step that comprises estimating at least one condition of at least one of the at least one component of the represented railway infrastructure system,
an asset condition monitoring step that comprises estimating at least one condition of at least one of the at least one asset of the represented railway infrastructure system, and
a network condition monitoring step that comprises estimating at least one condition of at least one of the at least one network of the represented railway infrastructure system.

7. The method according to claim 1, wherein the predicting step comprises
at least one of the at least one model evaluation step and
evaluating a prediction model of the set of prediction models representing the development of a quantity relating to a degradation of an element in future, wherein said prediction model represents the development at at least one point of time in future.

8. The method according to claim 1, wherein
at least one model of the set of prediction models that represents a condition of an element of the represented railway infrastructure system is obtained from or updated with data relating to said condition of the element,
at least one model of the set of prediction models that represents a condition of an element of the represented railway infrastructure system is obtained from or updated with data relating to a corresponding condition of at least one other element of a corresponding type, and/or
predicting for at least one element of the represented railway infrastructure system at least one of a degradation, a type of the degradation, a severity of the degradation, a type of a failure, a presence of an anomaly, a remaining useful lifetime, a performance and a probability of a failure, and thus generating prediction information for the at least one element.

9. The method according to claim 1, wherein the predicting step comprises at least one of
a component predicting step that comprises predicting at least one condition of at least one of the component(s) of the represented railway infrastructure system,
an asset predicting step that comprises predicting at least one condition of at least one of the asset(s) of the represented railway infrastructure system, and
a network predicting step that comprises predicting at least one condition of at least one of the network(s) of the represented railway infrastructure system.

10. The method according to claim 9, wherein the component predicting step comprises evaluating at least one model from the set of prediction models, wherein the at least one model represents a future development of at least one of the at least one condition of the component as a function of data of at least one data type selected from sensed data, load data, environment data, maintenance data, and specification data, wherein the data of the at least one data type relate to the component or to an asset that comprises the component.

11. The method according to claim 9, wherein the network predicting step comprises at least one of
predicting an availability of at least one route in the at least one network at a future point in time, and
predicting a capacity of at least one route in the at least one network at a future point in time.

12. The method according to claim 9, wherein the predicting step comprises predicting the condition of at least two elements of the network, and wherein the network predicting step comprises combining the predicted conditions of the at least two elements with the topology and/or operating rules of the network.

13. The method according to claim 1, wherein the method comprises at least one of
a data quality estimation step that comprises estimating at least one quality of data regarding the represented railway infrastructure system by the data processing system, and
a model validity estimation step that comprises estimating at least one validity of at least one result of evaluating at least one model of the set(s) of models relating to the represented railway infrastructure system by the data processing system.

14. The method according to claim 13, wherein the optimisation step comprises
estimating for each of a plurality of combinations of activities from the at least one of the inspection activities and maintenance activities at least one possible outcome, and
selecting at least one combination of activities from the plurality of combinations of activities based on an optimization criterion.

15. A system comprising at least one data processing apparatus and at least one sensor configured to sense data relating to a represented railway infrastructure system or a portion thereof, wherein the system is configured to carry out the method steps according to claim 1.

16. A computer program product comprising instructions, which, when the program is executed by the data processing system, cause the data processing system to perform the method steps according to claim 1.
